(19) United States
(12) Patent Application Publication
(10) Pub. No.: US 2020/0251831 A1
(43) Pub. Date: Aug. 6, 2020

(54) SLOT ARRAY ANTENNA

(71) Applicants: Nidec Corporation, Kyoto (JP); WGR Co., Ltd., Kyoto-city (JP)

(72) Inventors: Hideki KIRINO, Kyoto-city (JP); Yosuke SATO, Kyoto (JP)

(21) Appl. No.: 16/781,247

(22) Filed: Feb. 4, 2020

(30) Foreign Application Priority Data
Feb. 5, 2019 (JP) 2019-018405
Jul. 8, 2019 (JP) 2019-127158

(51) Int. Cl. H01Q 21/06; H01P 3/123; H01P 3/02; H01Q 21/00; H01Q 13/10; G01S 7/03; H01Q 13/22

(52) U.S. Cl. CPC H01Q 21/064; H01P 3/123; H01P 3/02; H01Q 13/22; H01Q 13/10; G01S 7/03; H01Q 21/005

(57) ABSTRACT

A slot array antenna includes first and second conductors. The first conductor includes first type of slots that open in a first conductive surface, and second type of slots that open in a second conductive surface and are arranged side by side in a first direction. The opening of each first type of slot extends along a second direction that is inclined with respect to the first direction. Each second type of slot includes a lateral portion extending along a third direction that intersects the first direction, and a vertical portion being connected to an end of the lateral portion and extending along a fourth direction that intersects the third direction. Inside the first conductor, each second type of slot includes two or more sites of connection at which the second type of slot is connected to a first type of slot.

### CROSS REFERENCE TO RELATED APPLICATION

The present invention claims priority under 35 U.S.C. § 119 to Japanese Application No. 2019-018405 filed on Feb. 5, 2019 and Japanese Application No. 2019-127158 filed on Jul. 8, 2019, the entire contents of each application are incorporated herein by reference.

### 1. FIELD OF THE INVENTION

The present disclosure relates to a slot array antenna.

### 2. BACKGROUND

Examples of waveguiding structures including an artificial magnetic conductor are disclosed in the specification of U.S. Pat. No. 8,779,995, the specification of U.S. Pat. No. 8,803,638, the specification of European Patent Application Publication No. 1331688 and the specification of U.S. Pat. No. 10,027,032. An artificial magnetic conductor is a structure which artificially realizes the properties of a perfect magnetic conductor (PMC), which does not exist in nature. One property of a perfect magnetic conductor is that “a magnetic field on its surface has zero tangential component”. This property is the opposite of the property of a perfect electric conductor (PEC), i.e., “an electric field on its surface has zero tangential component”. Although no perfect magnetic conductor exists in nature, it can be embodied by an artificial structure, e.g., an arrangement of a plurality of electrically conductive rods. An artificial magnetic conductor functions as a perfect magnetic conductor in a specific frequency band which is defined by its structure. An artificial magnetic conductor restrains or prevents an electromagnetic wave of any frequency that is contained in the specific frequency band (i.e., a propagation-restricted band) from propagating along the surface of the artificial magnetic conductor. For this reason, the surface of an artificial magnetic conductor may be referred to as a high impedance surface.

In the waveguide devices disclosed in the specification of U.S. Pat. No. 8,779,995, the specification of U.S. Pat. No. 8,803,638, the specification of European Patent Application Publication No. 1331688 and the specification of U.S. Pat. No. 10,027,032, an artificial magnetic conductor may be realized by a plurality of electrically conductive rods which are arrayed along row and column directions. Each of these waveguide devices includes, as a whole, a pair of opposing electrically conductive plates. One conductive plate has a ridge protruding toward the other conductive plate, and stretches of an artificial magnetic conductor extending on both sides of the ridge. An electrically-conductive upper face of the ridge opposes, via a gap, a conductive surface of the other conductive plate. An electromagnetic wave having a wavelength which is contained in the propagation-restricted band of the artificial magnetic conductor propagates along the ridge, in the space (gap) between this conductive surface and the upper face of the ridge. Such a waveguide is referred to as a WRG (Waffle-iron Ridge waveguide) or a WRG waveguide.

An array antenna in which independent signals can be input to or output from its respective antenna elements is useful in a wide range fields, such as sensing devices, e.g., radars, and wireless communication systems. An array antenna that includes a plurality of horn antenna elements is especially useful because of its wide frequency band and low losses.

FIG. 25 of the specification of U.S. Pat. No. 8,779,995 discloses a slot array antenna that includes a plurality of slots as radiating elements (which are also referred to as “antenna elements”). In this slot array antenna, a plurality of rows of slots (radiating element rows) are disposed at equal intervals on an electrically conductive plate opposing the upper face of a ridge. From the rear side of another electrically conductive plate which has the ridge thereon, an electromagnetic wave is fed to a waveguide existing on the ridge. The radiating element rows are disposed at a plurality of sites where electromagnetic waves propagating therethrough will have an identical phase. With such construction, electromagnetic waves with an equal phase are radiated from the plurality of radiating elements.

In the structure described in the specification of U.S. Pat. No. 8,779,995, the arraying interval of radiating elements is set equal to the wavelength of an electromagnetic wave within the waveguide or an integer multiple thereof. This makes it difficult for the plurality of radiating elements to be disposed densely. In a WRG waveguide, the wavelength of an electromagnetic wave within the waveguide is longer than its wavelength in free space; therefore, in the above construction, the arraying interval of radiating elements will also be longer than the free-space wavelength. This is likely to result in unfavorable phenomena such as grating lobes.

### SUMMARY

Example embodiments of the present disclosure provide slot array antennas in each of which a plurality of radiating elements are able to be arranged more densely.

A slot array antenna according to an example embodiment of the present disclosure includes a first electrical conductor including a first electrically conductive surface and a second electrically conductive surface that is located on an opposite side from the first electrically conductive surface, a second electrical conductor including a third electrically conductive surface opposing the second electrically conductive surface, a waveguide located between the first electrical conductor and the second electrically conductor, the waveguide including an electrically-conductive waveguide surface opposing the second electrically conductive surface or the third electrically conductive surface, and the waveguide extending in a direction that extends along the second electrically conductive surface or the third electrically conductive surface, and a plurality of electrically conductive rods disposed around the waveguide. The first electrical conductor includes a plurality of first type of slots that open in the first electrically conductive surface, the plurality of first type of slots being arranged in a first direction, and a plurality of second type of slots that open in the second electrically conductive surface, the plurality of second type of slots being arranged in the first direction. An opening in the first electrically conductive surface of each of the plurality of first type of slots has a shape extending along a second direction that is inclined with respect to the first direction. Each of the plurality of second type of slots includes a lateral portion extending along a third direction that intersects the first direction and a vertical portion being connected to the lateral portion and extending along a fourth direction that intersects the third direction. Inside the first electrical conductor, each of the plurality of second type of slots includes two or more sites of connection at which the second type of slot is connected to two adjacent first type of slots among the plurality of first type of slots. At least one of the two or more sites of connection is a site at which the vertical portion of the second type of slot is connected to the first type of slot. The waveguide surface is opposed to the respective lateral portions of the second type of slots, or is split at positions corresponding to the respective lateral portions of the second type of slots.

According to an example embodiment of the present disclosure, a plurality of radiating elements are able to be arranged more densely.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view schematically showing an example of a waveguide device.

FIG. 2A is a diagram schematically showing a construction for a waveguide device 100, in a cross section parallel to the XZ plane.

FIG. 2B is a diagram schematically showing another construction for the waveguide device 100, in a cross section parallel to the XZ plane.

FIG. 3 is another perspective view schematically illustrating the construction of the waveguide device 100, illustrated so that the spacing between a conductive member 110 and a conductive member 120 is exaggerated.

FIG. 4 is a diagram showing an exemplary range of dimension of each member in the structure shown in FIG. 2A.

FIG. 5A is a cross-sectional view showing an exemplary structure where only a waveguide face 122a, defining an upper face of the waveguide member 122, is electrically conductive, while any portion of the waveguide member 122 other than the waveguide face 122a is not electrically conductive.

FIG. 5B is a diagram showing a variant in which the waveguide member 122 is not formed on the conductive member 120.

FIG. 5C is a diagram showing an exemplary structure where the conductive member 120, the waveguide member 122, and each of the plurality of conductive rods 124 are composed of a dielectric surface that is coated with an electrically conductive material such as a metal.

FIG. 5D is a diagram showing an exemplary structure having a dielectric layer 110b or 120b on the outermost surface of each of the conductive members 110 and 120, the waveguide member 122, and the plurality of conductive rods 124.

FIG. 5E is a diagram showing another exemplary structure having a dielectric layer 110b or 120b on the outermost surface of each of the conductive members 110 and 120, the waveguide member 122, and the plurality of conductive rods 124.

FIG. 5F is a diagram showing an example where the height of the waveguide member 122 is lower than the height of the conductive rods 124 and a portion of a conductive surface 110a of the conductive member 110 that opposes the waveguide face 122a protrudes toward the waveguide member 122.

FIG. 5G is a diagram showing an example where, further in the structure of FIG. 5F, portions of the conductive surface 110a that oppose the conductive rods 124 protrude toward the conductive rods 124.

FIG. 6A is a diagram showing an example where a conductive surface 110a of the conductive member 110 is shaped as a curved surface.

FIG. 6B is a diagram showing an example where also a conductive surface 120a of the conductive member 120 is shaped as a curved surface.

FIG. 7A is a diagram schematically showing an electromagnetic wave that propagates in a narrow space, i.e., a gap between a waveguide face 122a of a waveguide member 122 and a conductive surface 110a of the conductive member 110.

FIG. 7B is a diagram schematically showing a cross section of a hollow waveguide.

FIG. 7C is a cross-sectional view showing an implementation in which two waveguide members 122 are provided on the conductive member 120.

FIG. 7D is a diagram schematically showing a cross section of a waveguide device in which two hollow waveguides are placed side-by-side.

FIG. 8A is a perspective view schematically showing partially a construction of a slot antenna array 200 utilizing a WRG structure.

FIG. 8B is a diagram schematically showing a partial cross section which passes through the centers of two slots 112 of the slot antenna array 200 that are arranged along the X direction, the cross section being taken parallel to the XZ plane.

FIG. 9 is a perspective view showing a slot array antenna according to a first example embodiment.

FIG. 10 is a perspective view showing the structure at a second conductive surface side of a first conductive member.

FIG. 11 is a perspective view showing the structure on a second conductive member.

FIG. 12 is a perspective view showing enlarged a portion of the structure at the front side of the first conductive member.

FIG. 13 is a plan view showing enlarged a portion of the structure at the front side of the first conductive member.

FIG. 14 is a plan view showing the structure of a second type of slot.

FIG. 15A is a perspective view showing recesses on the inside of a second type of slot.

FIG. 15B is a perspective view showing protrusions on the inside of a second type of slot.

FIG. 16 is a perspective view showing a slot array antenna according to a second example embodiment.

FIG. 17 is a diagram showing a cross-sectional structure of a portion of the slot array antenna according to the second example embodiment.

FIG. 18 is a diagram showing an exemplary structure on the second conductive member.

FIG. 19 is a plan view showing a relative positioning of first type of slots and second type of slots.

FIG. 20 is a perspective view showing an example embodiment of a slot array antenna in which a plurality of radiating elements are arranged in a two-dimensional array.

FIG. 21 is a perspective view showing the structure of the slot array antenna shown in FIG. 20 without the first conductive member.

FIG. 22 is a diagram showing the structure of the slot array antenna of FIG. 20 in more detail.

FIG. 23 is a diagram showing the structure at the rear side of the first conductive member of the slot array antenna shown in FIG. 20.

FIG. 24A is a perspective view showing a slot array antenna according to a third example embodiment.

FIG. 24B is a diagram showing the slot array antenna according to the third example embodiment as viewed from the front side.

FIG. 24C is a partially see-through perspective view showing the slot array antenna according to the third example embodiment.

FIG. 24D is a perspective view showing the structure at the rear side of the first conductive member of the slot array antenna according to the third example embodiment.

FIG. 25A is a diagram showing a first variant of a second type of slot.

FIG. 25B is a diagram showing a second variant of a second type of slot.

FIG. 25C is a diagram showing a third variant of a second type of slot.

FIG. 25D is a diagram showing a relative positioning of a second type of slot with respect to first type of slots according to the third variant.

FIG. 26A is a perspective view schematically showing a slot array antenna according to a fourth example embodiment.

FIG. 26B is a partially see-through perspective view schematically showing the slot array antenna according to the fourth example embodiment.

FIG. 26C is an upper plan view schematically showing the slot array antenna according to the fourth example embodiment.

FIG. 27A is a perspective view schematically showing a slot array antenna according to a variant of the fourth example embodiment.

FIG. 27B is a plan view schematically showing the structure at the front side of the first conductive member of the slot array antenna according to the variant of the fourth example embodiment.

FIG. 27C is a plan view schematically sowing the structure at the rear side of the first conductive member of the slot array antenna according to the variant of the fourth example embodiment.

### DETAILED DESCRIPTION

Prior to describing example embodiments of the present disclosure, an exemplary construction and operation of a WRG waveguide that may be used in example embodiments of the present disclosure will be described.

A WRG is a ridge waveguide that may be provided in a waffle-iron structure functioning as an artificial magnetic conductor. Such a ridge waveguide is able to realize an antenna feeding network with low losses in the microwave or millimeter wave band. Moreover, use of such a ridge waveguide allows antenna elements to be disposed with a high density.

FIG. 1 is a perspective view schematically showing an exemplary construction of such a waveguide device. FIG. 1 shows XYZ coordinates representing X, Y and Z directions that are orthogonal to one another. The waveguide device 100 shown includes electrically conductive members 110 and 120 of plate shape which are opposed and parallel to each other. A plurality of electrically conductive rods 124 are arrayed on the conductive member 120.

Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

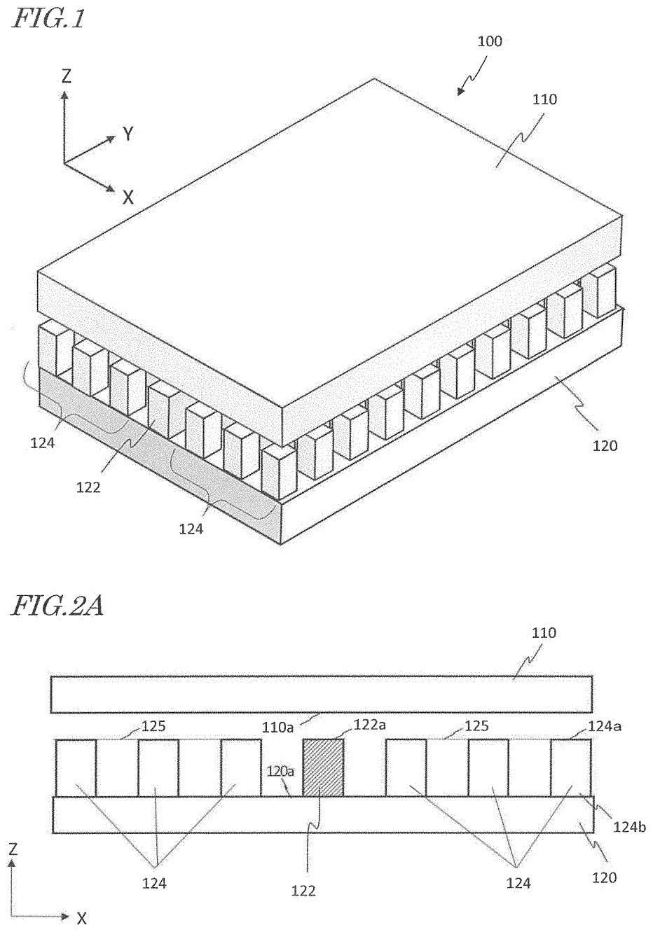

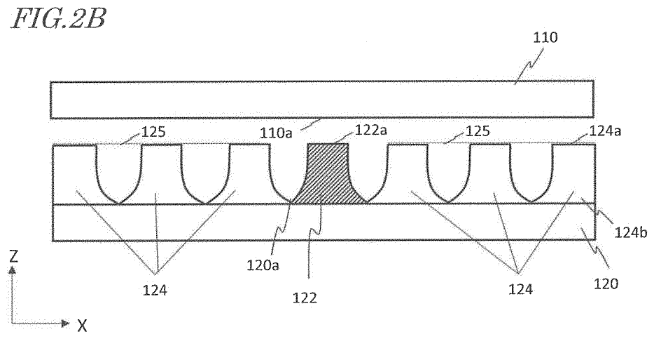

FIG. 2A is a diagram schematically showing the construction of a cross section of the waveguide device 100, taken parallel to the XZ plane. As shown in FIG. 2A, the conductive member 110 has an electrically conductive surface 110a on the side facing the conductive member 120. The conductive surface 110a has a two-dimensional expanse along a plane which is orthogonal to the axial direction (i.e., the Z direction) of the conductive rods 124 (i.e., a plane which is parallel to the XY plane). Although the conductive surface 110a is shown to be a smooth plane in this example, the conductive surface 110a does not need to be a plane, as will be described later.

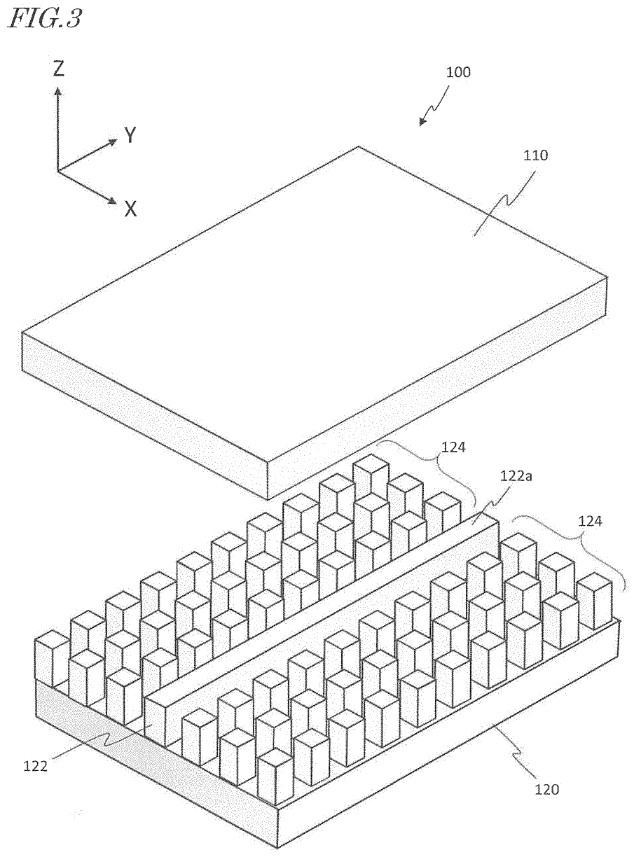

FIG. 3 is a perspective view schematically showing the waveguide device 100, illustrated so that the spacing between the conductive member 110 and the conductive member 120 is exaggerated for ease of understanding. In an actual waveguide device 100, as shown in FIG. 1 and FIG. 2A, the spacing between the conductive member 110 and the conductive member 120 is narrow, with the conductive member 110 covering over all of the conductive rods 124 on the conductive member 120.

FIG. 1 to FIG. 3 only show portions of the waveguide device 100. The conductive members 110 and 120, the waveguide member 122, and the plurality of conductive rods 124 actually extend to outside of the portions illustrated in the figures. At an end of the waveguide member 122, as will be described later, a choke structure for preventing electromagnetic waves from leaking into the external space is provided. The choke structure may include a row of conductive rods that are adjacent to the end of the waveguide member 122, for example.

See FIG. 2A again. The plurality of conductive rods 124 arrayed on the conductive member 120 each have a leading end 124a opposing the conductive surface 110a. In the example shown in the figure, the leading ends 124a of the plurality of conductive rods 124 are on the same plane or substantially the same plane. This plane defines the surface 125 of an artificial magnetic conductor. Each conductive rod 124 does not need to be entirely electrically conductive, so long as it at least includes an electrically conductive layer that extends along the upper face and the side face of the rod-like structure. Although this electrically conductive layer may be located at the surface layer of the rod-like structure, the surface layer may be composed of an insulation coating or a resin layer with no electrically conductive layer existing on the surface of the rod-like structure. Moreover, each conductive member 120 does not need to be entirely electrically conductive. Of the surfaces of the conductive member 120, a face carrying the plurality of conductive rods 124 may be electrically conductive, such that the electrical conductor electrically interconnects the surfaces of adjacent ones of the plurality of conductive rods 124. Moreover, the electrically conductive layer of the conductive member 120 may be covered with an insulation coating or a resin layer. In other words, the entire combination of the conductive member 120 and the plurality of conductive rods 124 may at least include an electrically conductive layer with rises and falls opposing the conductive surface 110a of the conductive member 110.

On the conductive member 120, a ridge-like waveguide member 122 is provided among the plurality of conductive rods 124. More specifically, stretches of an artificial magnetic conductor are present on both sides of the waveguide member 122, such that the waveguide member 122 is sandwiched between the stretches of artificial magnetic conductor on both sides. As can be seen from FIG. 3, the waveguide member 122 in this example is supported on the conductive member 120, and extends linearly along the Y direction. In the example shown in the figure, the waveguide member 122 has the same height and width as those of the conductive rods 124. As will be described later, however, the height and width of the waveguide member 122 may respectively differ from those of the conductive rod 124. Unlike the conductive rods 124, the waveguide member 122 extends along a direction (which in this example is the Y direction) in which to guide electromagnetic waves along the conductive surface 110a. Similarly, the waveguide member 122 does not need to be entirely electrically conductive, but may at least include an electrically conductive waveguide face 122a opposing the conductive surface 110a of the conductive member 110. The conductive member 120, the plurality of conductive rods 124, and the waveguide member 122 may be portions of a continuous single-piece body. Furthermore, the conductive member 110 may also be a portion of such a single-piece body.

On both sides of the waveguide member 122, the space between the surface 125 of each stretch of artificial magnetic conductor and the conductive surface 110a of the conductive member 110 does not allow an electromagnetic wave of any frequency that is within a specific frequency band to propagate. This frequency band is called a “prohibited band”. The artificial magnetic conductor is designed so that the frequency of an electromagnetic wave (signal wave) to propagate in the waveguide device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the width of each conductive rod 124; the interval between conductive rods 124; and the size of the gap between the leading end 124a and the conductive surface 110a of each conductive rod 124.

Next, with reference to FIG. 4, the dimensions, shape, positioning, and the like of each member in the structure shown in FIG. 2A will be described.

The waveguide device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110a of the conductive member 110 and the waveguide face 122a of the waveguide member 122. Moreover, λm denotes a wavelength, in free space, of an electromagnetic wave of the highest frequency in the operating frequency band. The end of each conductive rod 124 that is in contact with the conductive member 120 is referred to as the “root”. As shown in FIG. 4, each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

(2) Distance from the Root of the Conductive Rod to the Conductive Surface of the Conductive Member 110

The distance from the root 124b of each conductive rod 124 to the conductive surface 110a of the conductive member 110 may be longer than the height of the conductive rods 124, while also being less than λm/2. When the distance is λm/2 or more, resonance may occur between the root 124b of each conductive rod 124 and the conductive surface 110a, thus reducing the effect of signal wave containment.

The distance from the root 124b of each conductive rod 124 to the conductive surface 110a of the conductive member 110 corresponds to the spacing between the conductive member 110 and the conductive member 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, λm equals 3.8934 mm in this case, so that the spacing between the conductive member 110 and the conductive member 120 may be set to less than a half of 3.8934 mm. So long as the conductive member 110 and the conductive member 120 realize such a narrow spacing while being disposed opposite from each other, the conductive member 110 and the conductive member 120 do not need to be strictly parallel. Moreover, when the spacing between the conductive member 110 and the conductive member 120 is less than λm/2, a whole or a part of the conductive member 110 and/or the conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

Although the conductive surface 120a is illustrated as a plane in the example shown in FIG. 2A, example embodiments of the present disclosure are not limited thereto. For example, as shown in FIG. 2B, the conductive surface 120a may be the bottom parts of faces each of which has a cross section similar to a U-shape or a V-shape. The conductive surface 120a will have such a structure when each conductive rod 124 or the waveguide member 122 is shaped with a width which increases toward the root. Even with such a structure, the device shown in FIG. 2B can function as a waveguide device according to an example embodiment of the present disclosure so long as the distance between the conductive surface 110a and the conductive surface 120a is less than a half of the wavelength λm.

(3) Distance L2 from the Leading End of the Conductive Rod to the Conductive Surface

The distance L2 from the leading end 124a of each conductive rod 124 to the conductive surface 110a is set to less than λm/2. When the distance is λm/2 or more, a propagation mode where electromagnetic waves reciprocate between the leading end 124a of each conductive rod 124 and the conductive surface 110a may occur, thus no longer being able to contain an electromagnetic wave. Note that, among the plurality of conductive rods 124, at least those which are adjacent to the waveguide member 122 do not have their leading ends in electrical contact with the conductive surface 110a. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110a. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straightforward regularity. The conductive rods 124 may also vary in shape and size depending on the position on the conductive member 120.

The surface 125 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguide device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide member 122), i.e., the length from the root 124b to the leading end 124a, may be set to a value which is shorter than the distance (i.e., less than λm/2) between the conductive surface 110a and the conductive surface 120a, e.g., λo/4.

### (5) Width of the Waveguide Face

The width of the waveguide face 122a of the waveguide member 122, i.e., the size of the waveguide face 122a along a direction which is orthogonal to the direction that the waveguide member 122 extends, may be set to less than λm/2 (e.g. λo/8). If the width of the waveguide face 122a is λm/2 or more, resonance will occur along the width direction, which will prevent any WRG from operating as a simple transmission line.

### (6) Height of the Waveguide Member

The height (i.e., the size along the Z direction in the example shown in the figure) of the waveguide member 122 is set to less than λm/2. The reason is that, if the distance is λm/2 or more, the distance between the root 124b of each conductive rod 124 and the conductive surface 110a will be λm/2 or more.

### (7) Distance L1 Between the Waveguide Face and the Conductive Surface

The distance L1 between the waveguide face 122a of the waveguide member 122 and the conductive surface 110a is set to less than λm/2. If the distance is λm/2 or more, resonance will occur between the waveguide face 122a and the conductive surface 110a, which will prevent functionality as a waveguide. In one example, the distance L1 is λm/4 or less. In order to ensure manufacturing ease, when an electromagnetic wave in the extremely high frequency range is to propagate, the distance L1 is preferably λm/16 or more, for example.

The lower limit of the distance L1 between the conductive surface 110a and the waveguide face 122a and the lower limit of the distance L2 between the conductive surface 110a and the leading end 124a of each conductive rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using an MEMS (Micro-Electro-Mechanical System) technique to make a product in e.g. the terahertz range, the lower limit of the aforementioned distance is about 2 to about 3 μm.

Next, variants of waveguide structures including the waveguide member 122, the conductive members 110 and 120, and the plurality of conductive rods 124 will be described. The following variants are applicable to the WRG structure in any place in each example embodiment described below.

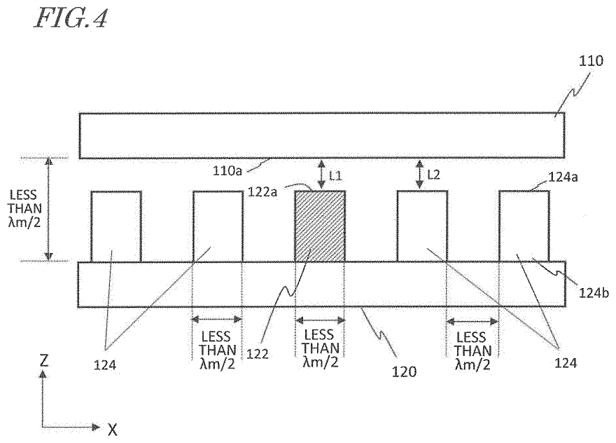

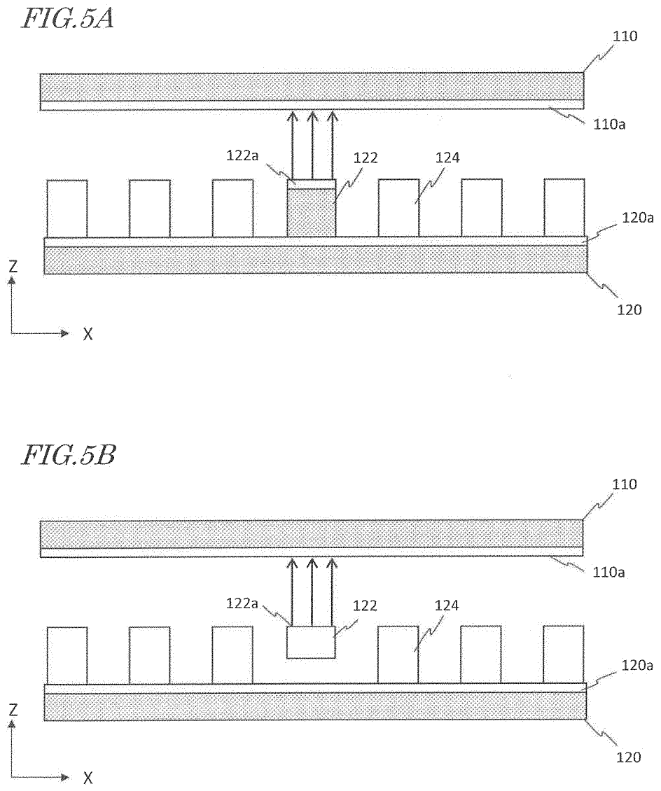

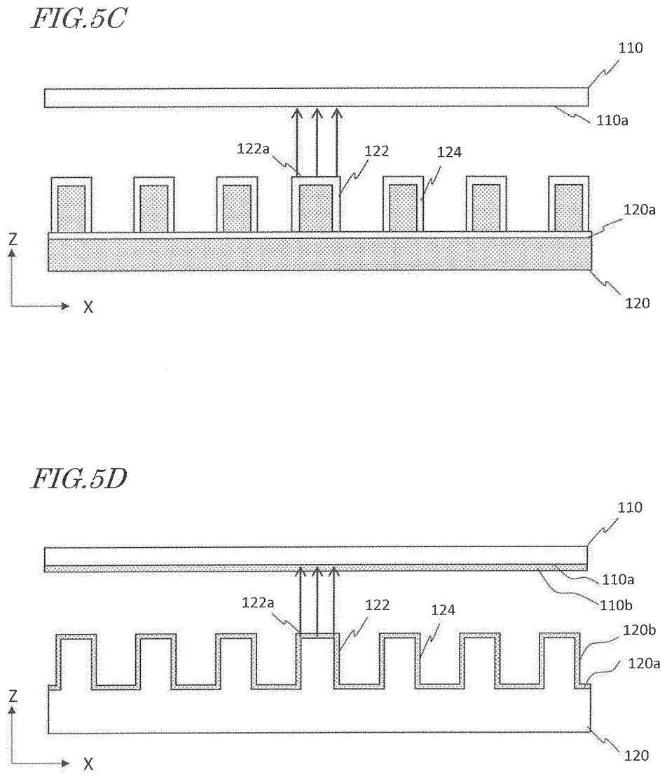

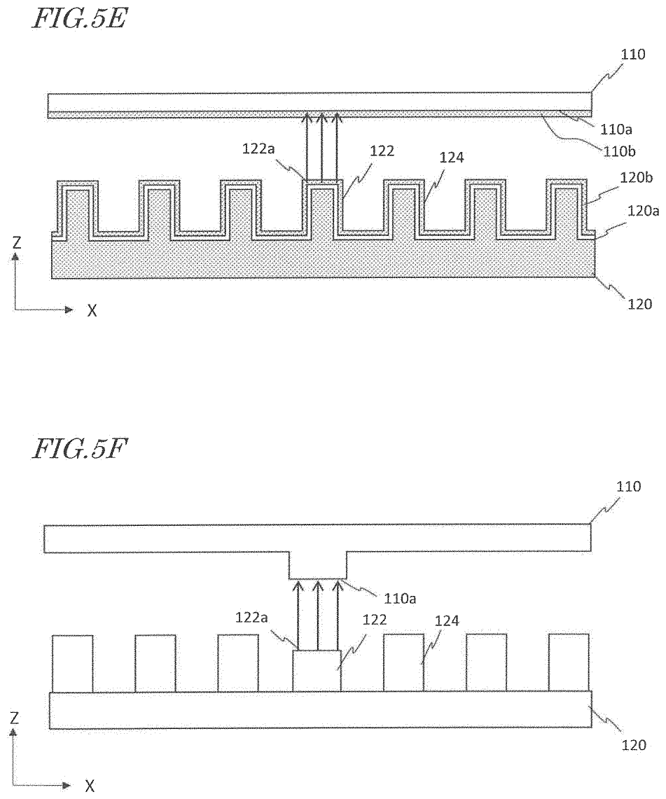

FIG. 5A is a cross-sectional view showing an exemplary structure in which only the waveguide face 122a, defining an upper face of the waveguide member 122, is electrically conductive, while any portion of the waveguide member 122 other than the waveguide face 122a is not electrically conductive. Both of the conductive member 110 and the conductive member 120 alike are only electrically conductive at their surface that has the waveguide member 122 provided thereon (i.e., the conductive surface 110a, 120a), while not being electrically conductive in any other portions. Thus, each of the waveguide member 122, the conductive member 110, and the conductive member 120 does not need to be electrically conductive.

FIG. 5B is a diagram showing a variant in which the waveguide member 122 is not formed on the conductive member 120. In this example, the waveguide member 122 is fixed to a supporting member (e.g., the inner wall of the housing) that supports the conductive member 110 and the conductive member. A gap exists between the waveguide member 122 and the conductive member 120. Thus, the waveguide member 122 does not need to be connected to the conductive member 120.

FIG. 5C is a diagram showing an exemplary structure where the conductive member 120, the waveguide member 122, and each of the plurality of conductive rods 124 are composed of a dielectric surface that is coated with an electrically conductive material such as a metal. The conductive member 120, the waveguide member 122, and the plurality of conductive rods 124 are connected to one another via the electrical conductor. On the other hand, the conductive member 110 is made of an electrically conductive material such as a metal.

FIG. 5D and FIG. 5E are diagrams each showing an exemplary structure in which dielectric layers 110c and 120c are respectively provided on the outermost surfaces of conductive members 110b and 120b, a waveguide member 122, and conductive rods 124. FIG. 5D shows an exemplary structure in which the surface of metal conductive members, which are electrical conductors, are covered with a dielectric layer. FIG. 5E shows an example where the conductive member 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110a and 120a (which are electrically conductive) from corrosion. It also prevents influences of a DC voltage, or an AC voltage of such a low frequency that it is not capable of propagation on certain WRG waveguides.

FIG. 5F is a diagram showing an example where the height of the waveguide member 122 is lower than the height of the conductive rods 124, and the portion of the conductive surface 110a of the conductive member 110 that opposes the waveguide face 122a protrudes toward the waveguide member 122. Even such a structure will operate in a similar manner to the above-described example embodiment, so long as the ranges of dimensions depicted in FIG. 4 are satisfied.

FIG. 5G is a diagram showing an example where, further in the structure of FIG. 5F, portions of the conductive surface 110a that oppose the conductive rods 124 protrude toward the conductive rods 124. Even such a structure will operate in a similar manner to the above-described example embodiment, so long as the ranges of dimensions depicted in FIG. 4 are satisfied. Instead of a structure in which the conductive surface 110a partially protrudes, a structure in which the conductive surface 110a is partially dented may be adopted.

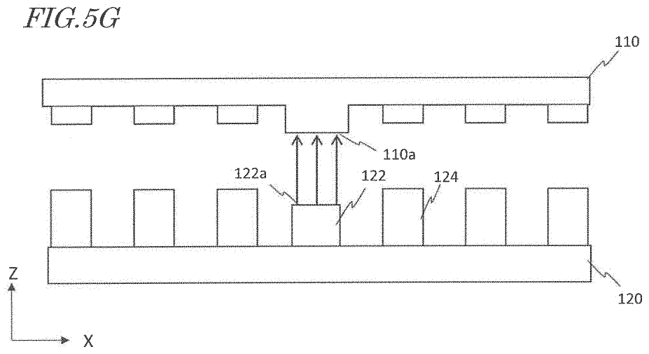

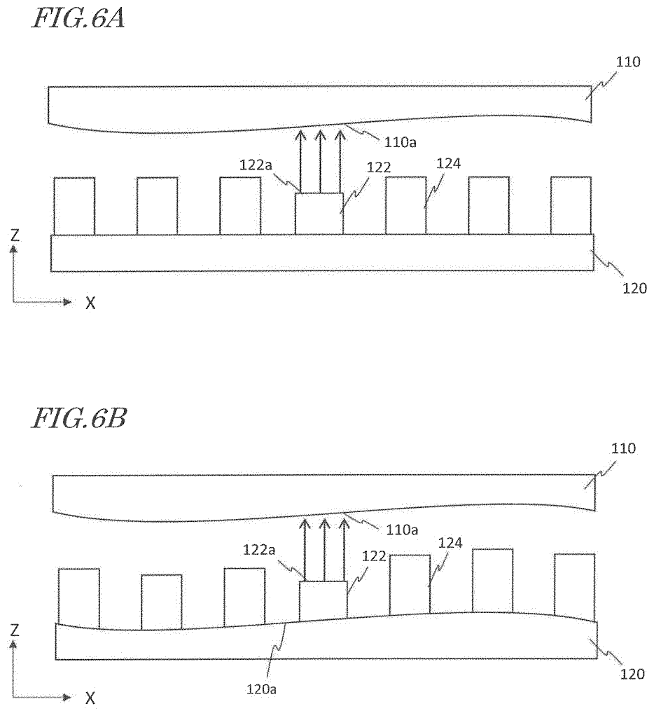

FIG. 6A is a diagram showing an example where a conductive surface 110a of the conductive member 110 is shaped as a curved surface. FIG. 6B is a diagram showing an example where also a conductive surface 120a of the conductive member 120 is shaped as a curved surface. As demonstrated by these examples, the conductive surfaces 110a and 120a may not be shaped as planes, but may be shaped as curved surfaces. A conductive member having a conductive surface which is a curved surface is also qualifies as a conductive member having a “plate shape”.

In the waveguide device 100 of the above-described construction, a signal wave of the operating frequency is unable to propagate in the space between the surface 125 of the artificial magnetic conductor and the conductive surface 110a of the conductive member 110, but propagates in the space between the waveguide face 122a of the waveguide member 122 and the conductive surface 110a of the conductive member 110. Unlike in a hollow waveguide, the width of the waveguide member 122 in such a waveguide structure does not need to be equal to or greater than a half of the wavelength of the electromagnetic wave to propagate. Moreover, the conductive member 110 and the conductive member 120 do not need to be electrically interconnected by a metal wall that extends along the thickness direction (i.e., in parallel to the YZ plane).

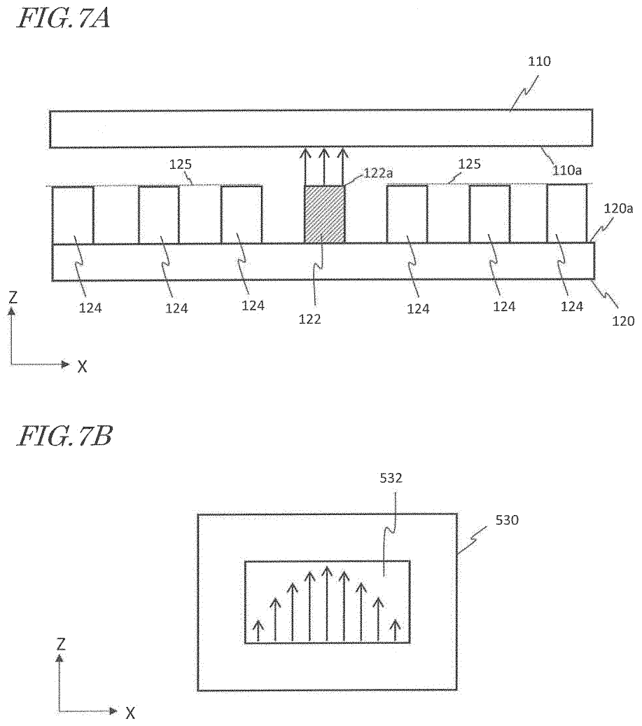

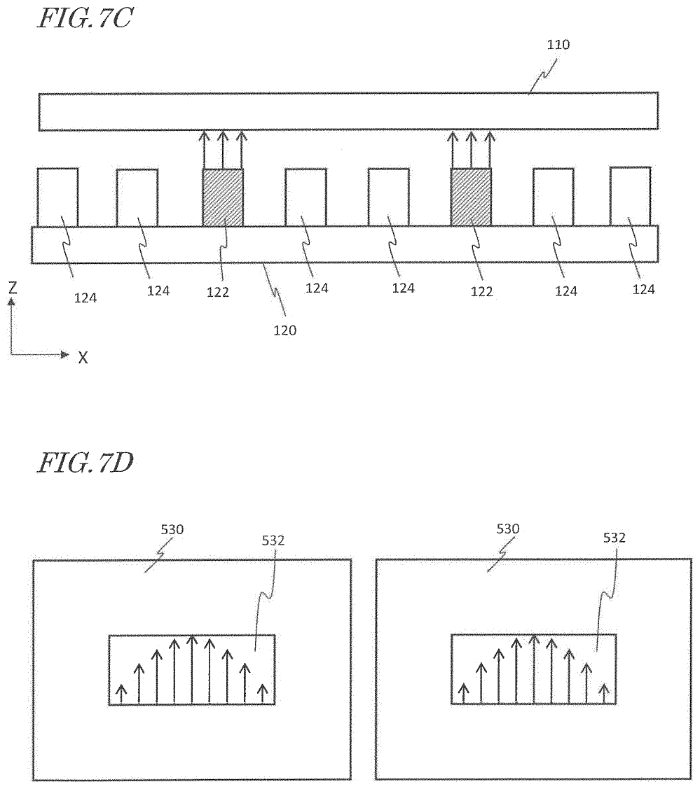

FIG. 7A schematically shows an electromagnetic wave that propagates in a narrow space, i.e., a gap between the waveguide face 122a of the waveguide member 122 and the conductive surface 110a of the conductive member 110. Three arrows in FIG. 7A schematically indicate the orientation of an electric field of the propagating electromagnetic wave. The electric field of the propagating electromagnetic wave is perpendicular to the conductive surface 110a of the conductive member 110 and to the waveguide face 122a.

On both sides of the waveguide member 122, stretches of artificial magnetic conductor that are created by the plurality of conductive rods 124 are present. An electromagnetic wave propagates in the gap between the waveguide face 122a of the waveguide member 122 and the conductive surface 110a of the conductive member 110. FIG. 7A is schematic, and does not accurately represent the magnitude of an electromagnetic field to be actually created by the electromagnetic wave. A part of the electromagnetic wave (electromagnetic field) propagating in the space over the waveguide face 122a may have a lateral expanse, to the outside (i.e., toward where the artificial magnetic conductor exists) of the space that is delineated by the width of the waveguide face 122a. In this example, the electromagnetic wave propagates in a direction (i.e., the Y direction) which is perpendicular to the plane of FIG. 7A. As such, the waveguide member 122 does not need to extend linearly along the Y direction, but may include a bend(s) and/or a branching portion(s) not shown. Since the electromagnetic wave propagates along the waveguide face 122a of the waveguide member 122, the direction of propagation would change at a bend, whereas the direction of propagation would ramify into plural directions at a branching portion.

In the waveguide structure of FIG. 7A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide face 122a is less than a half of the wavelength of the electromagnetic wave.

For reference, FIG. 7B schematically shows a cross section of a hollow waveguide 530. With arrows, FIG. 7B schematically shows the orientation of an electric field of an electromagnetic field mode (TE₁₀) that is created in the internal space 532 of the hollow waveguide 530. The lengths of the arrows correspond to electric field intensities. The width of the internal space 532 of the hollow waveguide 530 needs to be set to be broader than a half of the wavelength. In other words, the width of the internal space 532 of the hollow waveguide 530 cannot be set to be smaller than a half of the wavelength of the propagating electromagnetic wave.

FIG. 7C is a cross-sectional view showing an exemplary implementation where two waveguide members 122 are provided on the conductive member 120. An artificial magnetic conductor that is created by a row of plural conductive rods 124 exists between the two adjacent waveguide members 122. More accurately, stretches of artificial magnetic conductor created by the plurality of conductive rods 124 are present on both sides of each waveguide member 122, such that each waveguide member 122 is able to independently propagate an electromagnetic wave.

For reference's sake, FIG. 7D schematically shows a cross section of a waveguide device in which two hollow waveguides 530 are placed side-by-side. The two hollow waveguides 530 are electrically insulated from each other. Each space in which an electromagnetic wave is to propagate needs to be surrounded by a metal wall that defines the respective hollow waveguide 530. Therefore, the interval between the internal spaces 532 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 530 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguide device 100 including an artificial magnetic conductor can easily realize a structure in which waveguide members 122 are placed close to one another. Thus, such a waveguide device 100 can be suitably used in an antenna array that includes plural antenna elements in a close arrangement.

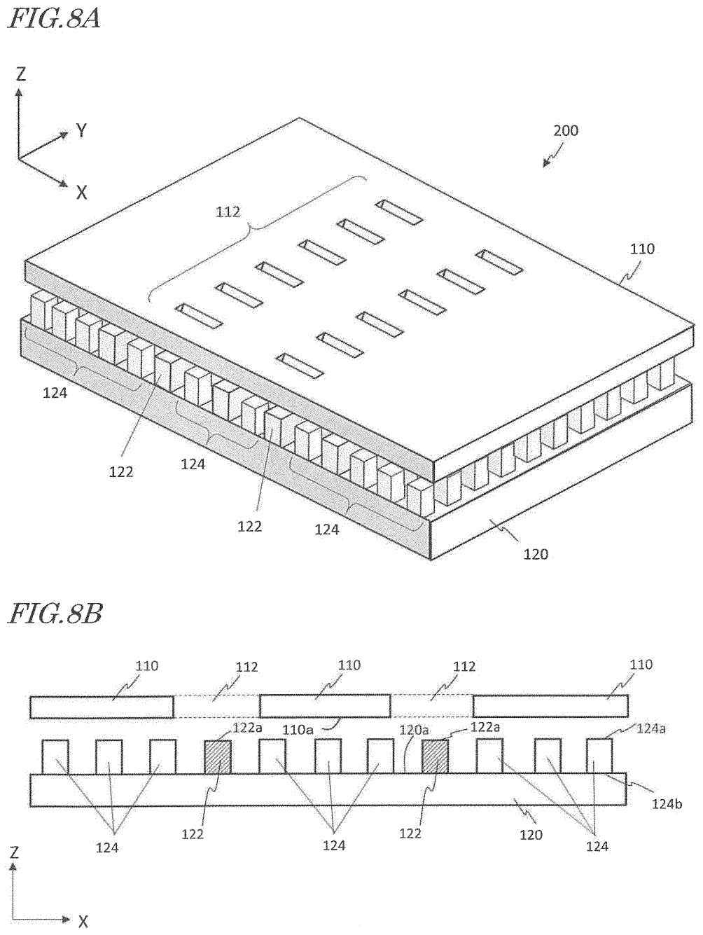

FIG. 8A is a perspective view schematically showing partially an exemplary construction of a slot antenna array 200 utilizing the above-described waveguide structure. FIG. 8B is a diagram schematically showing a partial cross section which passes through the centers of two slots 112 of the slot antenna array 200 that are arranged along the X direction, the cross section being taken parallel to the XZ plane. In the slot antenna array 200, the first conductive member 110 includes a plurality of slots 112 that are arrayed along the X direction and the Y direction. In this example, the plurality of slots 112 include two slot rows. Each slot row includes six slots 112 that are arranged along the Y direction at equal intervals. On the second conductive member 120, two waveguide members 122 that extend along the Y direction are provided. Each waveguide member 122 has an electrically-conductive waveguide face 122a opposing one slot row. In the region between the two waveguide members 122 and in the regions outside the two waveguide members 122, a plurality of conductive rods 124 are provided. The conductive rods 124 constitute an artificial magnetic conductor.

An electromagnetic wave is supplied from a transmission circuit (not shown) to the waveguide extending between the waveguide face 122a of each waveguide member 122 and the conductive surface 110a of the conductive member 110. As a result, the plurality of slots 112 that are arranged along the Y direction are excited, and electromagnetic waves with an equal phase are radiated from the respective slots 112.

In the construction shown in FIG. 8A and FIG. 8B, the arraying interval between a plurality of slots 112 (radiating element) arranged along the Y direction may be set equal the wavelength of an electromagnetic wave within the WRG waveguide, or an integer multiple thereof. As a result, electromagnetic waves with an equal phase can be radiated from the respective slots 112. However, when the arraying interval between the slots 112 is determined in this manner, the interval between two adjacent second type of slots 112 neighboring along the Y direction cannot be made sufficiently small, and thus unfavorable phenomena, e.g., grating lobes, may occur.

In order to solve the above problem, the inventors have arrived at the constructions described in example embodiments described below. Hereinafter, illustrative example embodiments according to the present disclosure will be described.

### Example Embodiment 1

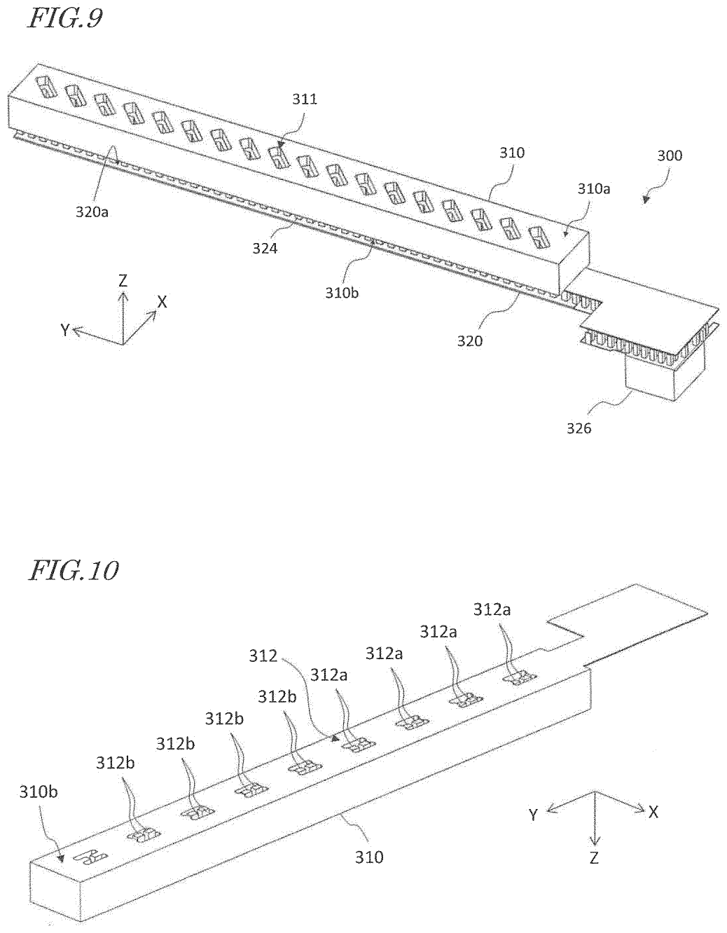

FIG. 9 is a perspective view showing the construction of a slot array antenna 300 according to a first example embodiment of the present disclosure. The slot array antenna 300 includes a first conductive member 310 and a second conductive member 320. The first conductive member 310 and the second conductive member 320 are layered with a gap therebetween. The first conductive member 310 and the second conductive member 320 may each be shaped by processing a metal plate, for example. Each of the conductive members 310 and 320 may also be produced by plating the surface of a molded piece of plastic, for example.

The first conductive member 310 has a first conductive surface 310a on the front side, and a second conductive surface 310b on the rear side. In the present specification, the side which is irradiated with an electromagnetic wave is referred to as “the front side”, and the opposite side as “the rear side”. On the front side, the second conductive member 320 has a third conductive surface 320a opposing the second conductive surface 310b. Each of the first conductive member 310 and the second conductive member 320 has a plate shape or a block shape. In the present example embodiment, each of the conductive surfaces 310a, 310b and 310c is flat, and is parallel to the XY plane.

The first conductive member 310 has a plurality of first type of slots 311 that open in the first conductive surface 310a. The plurality of first type of slots 311 are arranged along a first direction that extends along the first conductive surface 310a (which in the present example embodiment is the Y direction). The opening of each first type of slot 311 in the first conductive surface 310a has a shape extending along a second direction which is inclined with respect to the first direction (the Y direction). In the present example embodiment, the second direction is a direction inclined by about 45 degrees from the Y direction. Without being limited to 45 degrees, the angle between the second direction and the first direction may be set to any value that is greater than 0 degrees and smaller than 90 degrees. In the present example embodiment, the plurality of first type of slots 311 are arranged at a constant interval along the Y direction. Each first type of slot 311 functions as a radiating element.

FIG. 10 is a perspective view showing the structure at the rear side of the first conductive member 310. As shown in FIG. 10, the first conductive member 310 has a plurality of second type of slots 312 that open in the second conductive surface 310b. The plurality of second type of slots 312 are also arranged along the first direction (the Y direction). Note that the first conductive surface 310a is parallel to the second conductive surface 310b in this example embodiment. Therefore, the aforementioned first direction is parallel to both of the first conductive surface 310a and the second conductive surface 310b. However, more generally, a constitution in which the first conductive surface 310a and the second conductive surface 310b are not parallel to each other may be adopted. In such a constitution, although the openings of the first type of slots 311 and the openings of the second type of slots 312 are arranged along the first conductive surface 310a and the second conductive surface 310b, respectively, the two directions of the arrangements of the two types of openings are not spatially identical. However, the two directions are spatially in an identical virtual plane. In the present specification, in such a constitution, those directions are considered as identical and referred to as the “first direction”. The number of second type of slots 312 is a half of the number of first type of slots 311. Inside the first conductive member 310, each second type of slot 312 is continuous with two first type of slots 311 that are adjacent to each other. Each second type of slot 312 has a shape resembling the alphabetical letter “H” as viewed along the Z axis. Hereinafter, such a shape will be referred to as an “H shape”.

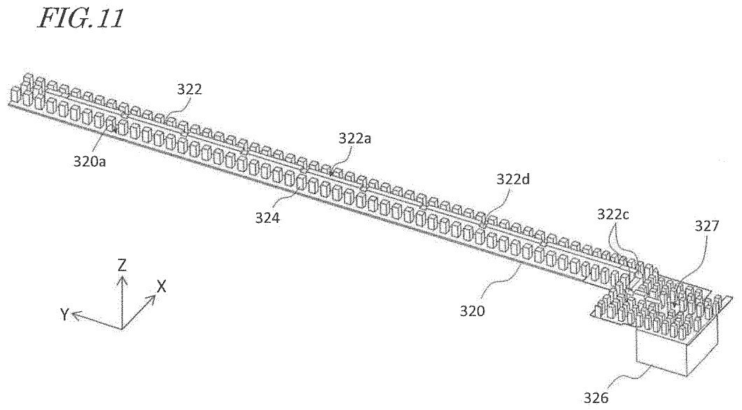

FIG. 11 is a perspective view showing the slot array antenna 300 without the first conductive member 310, such that the second conductive member 320 is exposed. As shown in FIG. 11, on the second conductive member 320, the slot array antenna 300 includes a waveguide member 322 and a plurality of conductive rods 324. The waveguide member 322 has a ridge-like structure protruding from the third conductive surface 320a. The plurality of conductive rods 324 protrude from the third conductive surface 320a, and are disposed around the waveguide member 322. The waveguide member 322 has an electrically-conductive waveguide face 322a opposing the second conductive surface 310b. The waveguide member 322 extends along the first direction, and the waveguide face 322a is at a position overlapping the central portion of each second type of slot 312, as seen through along the Z direction. A waveguide is defined between the waveguide face 322a and the second conductive surface 310b.

One end of the waveguide member 322 is connected to a hollow waveguide 326 via a port 327. A plurality of conductive rods 324 are also disposed around the port 327. The hollow waveguide 326 extends along the Z direction, and is connected to a transmission circuit not shown. Via the hollow waveguide 326, an electromagnetic wave is fed from the transmission circuit to a waveguide on the waveguide face 322a.

The waveguide face 322a of the waveguide member 322 according to the present example embodiment has a plurality of recesses 322d provided therein. The recesses 322d are provided for phase adjustments of signal waves that propagate along the waveguide face 322a. The positions of the recesses 322d are selected so that the phase of a signal wave at the position of each second type of slot 312 is appropriately altered to attain desired radiation characteristics.

The waveguide member 322 may have a bend(s) at which its longitudinal direction changes. In the example of FIG. 11, the waveguide member 322 includes two bends 322c. At each bend 322c and its vicinity, for the sake of impedance matching, the waveguide face 322a has a height which is different from the height in anywhere else.

The plurality of conductive rods 324 are disposed on opposite sides of the waveguide member 322 and around the port 327, thus constituting an artificial magnetic conductor. An electromagnetic wave cannot propagate in the space between the artificial magnetic conductor and the second conductive surface 310b. Therefore, while propagating in a waveguide between the waveguide face 322a and the second conductive surface 310b, the electromagnetic wave will excite each second type of slot 312. As each second type of slot 312 is excited, the two first type of slots 311 that are continuous with that slot 312 are also excited. As a result, an electromagnetic wave is radiated from each first type of slot 311.

The second conductive member 320, the plurality of conductive rods 324, and the waveguide member 322 may be portions of a continuous single-piece body, or may be discrete from one another.

The second conductive member 320 shown in FIG. 9 to FIG. 11 is extremely thin, as compared to the first conductive member 310. Without being limited to such structure, the second conductive member 320 may have a thicker structure. The second conductive member 320 may have a thickness which is about a half of the height of each conductive rod 324, for example.

Next, the structures of the first type of slots 311 and the second type of slots 312 according to the present example embodiment will be described in more detail.

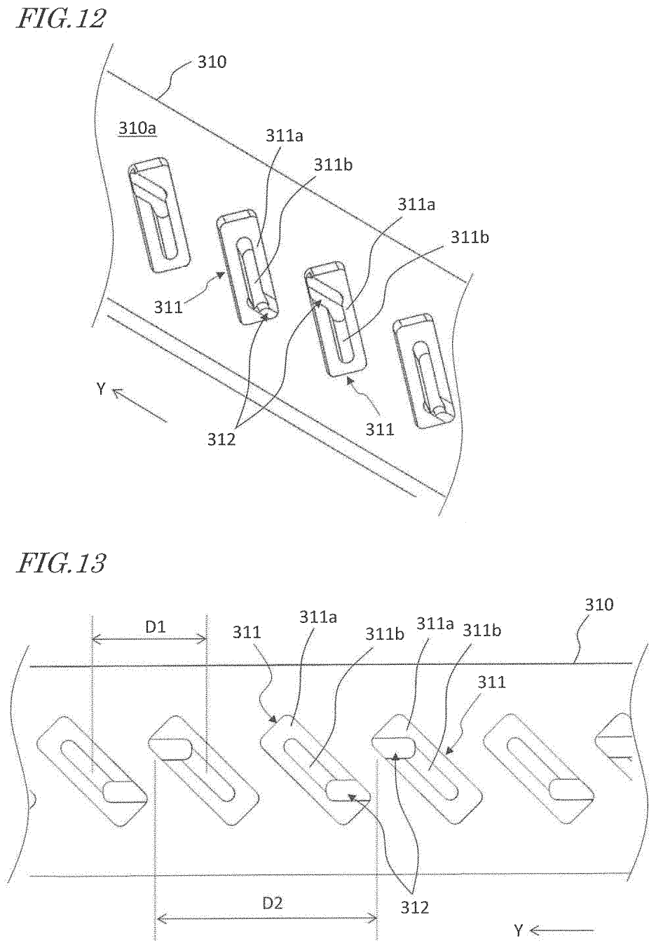

FIG. 12 is a diagram showing enlarged a portion of the first conductive member 310. FIG. 13 is a diagram showing the first conductive member 310 as viewed from the front side. As shown in the figure, the opening of each of the first type of slots 311 arranged along the first direction (the Y direction) extends along the second direction which is inclined with respect to the first direction, and has a near-rectangular shape. A large part of each first type of slot 311 does not extend through the first conductive member 310, but has a bottom. The bottom portion of each first type of slot 311 is referred to as a base 311a. In the center of the base 311a is a groove 311b that extends along the second direction. A portion of the end of each first type of slot 311 is continuous with a second type of slot 312 on the rear side, where it extends through the first conductive member 310. One second type of slot 312 is continuous with two adjacent first type of slots 311. The two sites at which each second type of slot 312 is respectively connected to the two first type of slots 311 penetrate through the first conductive member 310. In other words, each portion in which a first type of slot 311 and a second type of slot 312 overlap each other as viewed in a direction perpendicular to the first conductive surface 310a constitutes a throughhole that extends through the first conductive member 310 from the front side to the rear side.

In the present example embodiment, each first type of slot 311 has a staircase-like structure having a groove 311b provided inside the base 311a. The groove 311b extends along the direction that the first type of slot 311 extends. The width of the groove 311b is narrower than the width of the entire base 311a. Each first type of slot 311 may be shaped so that its width gradually increases from the base 311a toward its opening; in this case, the first type of slot 311 may not have the groove 311b. Thus, by providing steps or a slope inside the base 311a, the degree of impedance matching can be improved.

In the example of FIG. 12, the base 311a of each first type of slot 311 and one end of its groove 311b are continuous with a portion of a second type of slot 312. With such structure, an electromagnetic wave can be propagated between the second type of slot 312 and the first type of slot 311, such that the field direction of that electromagnetic wave is altered. Inside the second type of slot 312, the main direction of the electric field of the electromagnetic wave is parallel to the direction that the waveguide member 322 extends (i.e., the Y direction). On the other hand, inside the first type of slot 311, the main direction of the electric field is inclined by 45 degrees from the direction that the waveguide member 322 extends. Therefore, when the slot array antenna is placed so that the Y direction coincides with the vertical direction, a polarized electromagnetic radiation having a field component in a direction which is inclined by 45 degrees with respect to the vertical direction can be radiated. As described above, this angle of inclination is not limited to 45 degrees. However, when this angle is near 90 degrees, there will be substantially no electromagnetic wave propagating from the second type of slot 312 to the first type of slot 311.

As shown in FIG. 13, along the first direction (the Y direction), the interval D1 between two adjacent first type of slots 311 is narrower than the interval D2 between two adjacent second type of slots 312 neighboring along the first direction. In the present example embodiment, the arraying interval D1 of the first type of slots 311 is approximately a half of the arraying interval D2 of the second type of slots 312. With such construction, the radiating element that are defined by the first type of slots 311 can be disposed with a higher density than are the second type of slots 312. If the arraying interval D2 of the second type of slots 312 is equal to the wavelength of the electromagnetic wave within a WRG waveguide, the radiating elements can be disposed at an interval D1 which is approximately a half of that wavelength. Thus, since the radiating elements can be disposed densely, occurrence of grating lobes can be effectively suppressed.

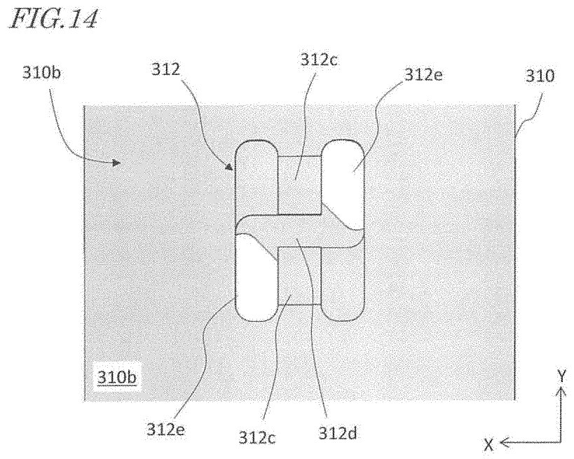

FIG. 14 is a plan view showing the structure of a second type of slot 312 more specifically. Each second type of slot 312 includes: a lateral portion 312d extending along a third direction (which in the present example embodiment coincides with the X direction) that intersects the first direction (the Y direction); and a pair of vertical portions 312e being respectively connected to both ends of the lateral portion 312d and extending along a fourth direction (which in the present example embodiment coincides with the Y direction) that intersects the third direction. Alternatively, a constitution in which the lateral portion 312d intersects at least one of the pair of vertical portions 312e may be adopted. In such a constitution, at least one of the ends of the lateral portion 312d extends through a portion at which the lateral portion 312d is connected to the vertical portion 312e. In this manner, one of the two vertical portions 312e is connected to the lateral portion 312d at one site, and another of the two vertical portions 312e is connected to the lateral portion 312e at another site. The third direction may be somewhat inclined with respect to the X direction. Similarly, the fourth direction may be somewhat inclined with respect to the Y direction. Each second type of slot 312 has two sites of connection, at which the second type of slot 312 is connected respectively to the two first type of slots 311 inside the first conductive member 310. In the present example embodiment, it is the two vertical portions 312e of the second type of slot 312 that are respectively connected to the two first type of slots 311 at these two sites of connection. The lateral portion 312d of each second type of slot 312 is opposed to the waveguide face 322a of the waveguide member 322.

Each second type of slot 312 according to the present example embodiment has an H shape. The lateral portion 312d, which is essentially perpendicular to the two vertical portions 312e, connects essentially central portions of the two vertical portions 312e together. The shape and size of such an H-shaped slot are to be determined so that higher-order resonance will not occur and that the slot impedance will not be too small. Let L be twice the length along the lateral portion 312d and one of the vertical portions 312e that extends from the center point of the H shape (i.e., the center point of the lateral portion 312d) to either end of the vertical portion 312e. This L may be chosen to be a length that satisfies λo/2<L<λo. For example, L may be set to about λo/2.

In the present example embodiment, a portion of each of the two vertical portions 312e of the second type of slot 312 constitutes a throughhole extending through the first conductive member 310. On the other hand, the lateral portion 312d does not extend through the first conductive member 310, but has a bottom inside the first conductive member 310. The lateral portion 312d is located on an opposite side of the first conductive surface 310a between two adjacent first type of slots 311 neighboring along the Y direction. On an opposite side from the bottom of the lateral portion 312d, the bottom of the first conductive surface 310a, as existing bet two adjacent first type of slots 311, is located.

In the present example embodiment, as shown in FIG. 10, the first conductive member 310 has a plurality of recesses 312a and a plurality of protrusions 312b on the second conductive surface 310b. Each recess 312a extends the spacing between the waveguide face 322a and the second conductive surface 310b relative to adjoining sites. Each protrusion 312b narrows the spacing between the waveguide face 322a and the second conductive surface 310b relative to adjoining sites. Each recess 312a or each protrusion 312b adjoins the lateral portion 312d and the vertical portions 312e of one of the plurality of second type of slots 312.

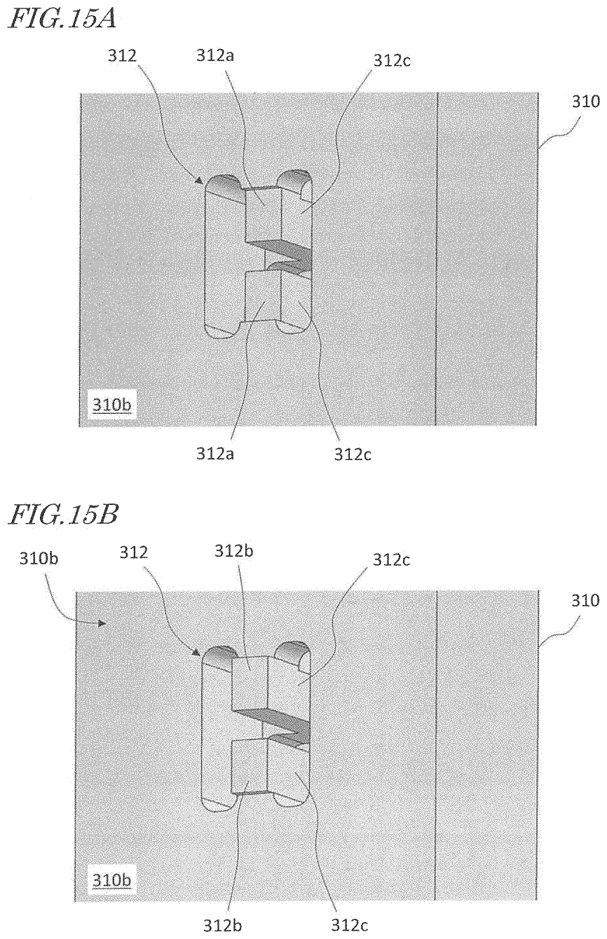

FIG. 15A is a perspective view showing an exemplary construction of recesses 312a provided in a second type of slot 312. In the second type of slot 312 shown in FIG. 15A, a pair of ridge portions 312c are provided adjoining the lateral portion 312d and the two vertical portions 312e. Two recesses 312a are shown located on end faces of the pair of ridge portions 312c. Each recess 312a is a site that is dented backward from the second conductive surface 310b, at an end face of a ridge portion 312c that is exposed at the second conductive surface 310b side. Providing the recesses 312a allows to extend the spacing between the second conductive surface 310b and the waveguide face 322a relative to adjoining sites, thus locally decrease the capacitance of the waveguide.

FIG. 15B is a perspective view showing an exemplary construction of protrusions 312b provided in a second type of slot 312. In the second type of slot 312 shown in FIG. 15B, two protrusions 312b are shown provided at the respective end faces of the pair of ridge portions 312c. Each protrusion 312b is a site that protrudes frontward of the second conductive surface 310b, at an end face of a ridge portion 312c that is exposed at the second conductive surface 310b side. Providing the protrusions 312b allows to narrow the spacing between the second conductive surface 310b and the waveguide face 322a relative to adjoining sites, thus locally increase the capacitance of the waveguide.

In the present example embodiment, as shown in FIG. 10, the end faces of the pair of ridge portions 312c of each second type of slot 312 are positioned closer to the waveguide face 322a, in a direction from the feeding end (−Y direction side) of electromagnetic waves to the terminating end (+Y direction side) of the waveguide. However, this excludes the second type of slot 312 that is located the closest to the terminating end. In other words, the spacing between the second conductive surface 310b and the waveguide face 322a becomes increasingly narrower from the feeding end toward the terminating end, except in the second type of slot 312 that is located the closest to the terminating end. If the end face of a ridge portion 312c is positioned backward of the second conductive surface 310b, that end face defines a recess 312a. Conversely, if the end face of a ridge portion 312c is positioned frontward of the second conductive surface 310b, that end face defines a protrusion 312b. In the example of FIG. 10, the four second type of slots 312 at the feeding end have recesses 312a; the next four second type of slots 312 have protrusions 312b; and the second type of slot 312 that is located the closest to the terminating end has neither a recess nor a protrusion.

As in the present example embodiment, by adjusting the end faces of the pair of ridge portions 312c of each second type of slot 312 in terms of height, the strength of coupling between the WRG waveguide and the second type of slots 312 can be adjusted. By appropriately performing this adjustment, the plurality of first type of slots 311 can be made to perform proper radiation as suited to the purpose. In the example of FIG. 10, the coupling between the waveguide and the second type of slot 312 becomes stronger in a direction from the feeding end (+Y direction side) of the waveguide to the terminating end (−Y direction side) of the waveguide. With such construction, the slot array antenna 300 can achieve a cosecant-squared characteristic, for example.

A cosecant-squared characteristic refers to characteristics where, given an angle θ with respect to the frontal direction, the intensity of a radiated electromagnetic wave is generally in proportion to a square of cosec θ (=1/sin θ). If the slot array antenna 300 has a cosecant-squared characteristic, when used as an antenna to be installed in e.g. a base station of wireless communications, the slot array antenna 300 can attain similar intensities of reception for radio waves from short-ranges to long-ranges.

### Example Embodiment 2

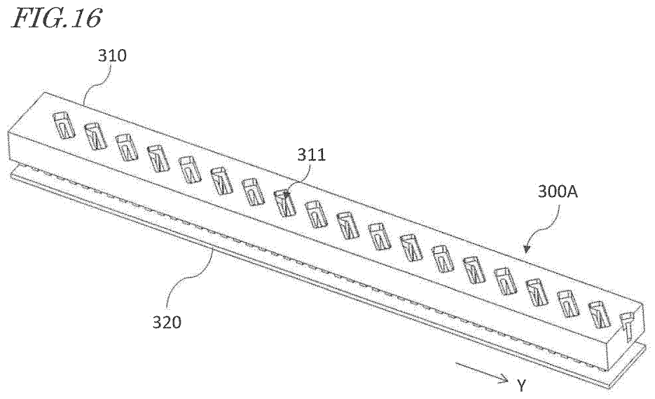

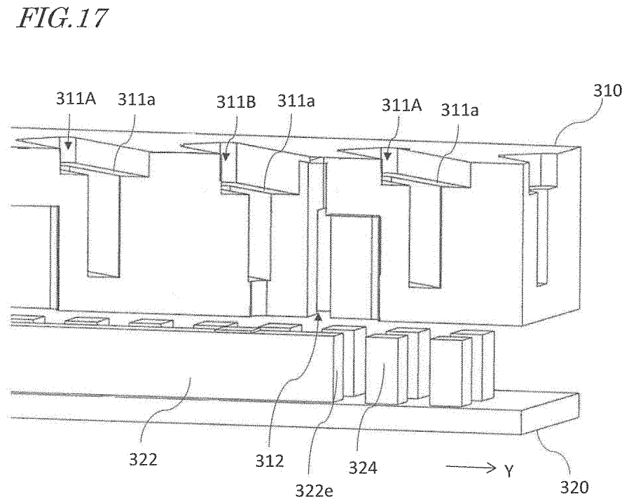

FIG. 16 is a perspective view showing the construction of a slot array antenna 300A according to a second example embodiment of the present disclosure. FIG. 17 is a cross-sectional view showing enlarged a portion of the structure of the slot array antenna 300A.

In the present example embodiment, bases 311a of a plurality of first type of slots 311 arranged along the Y direction have different depths from slot to slot. As shown in FIG. 17, the plurality of first type of slots 311 include first type of slots 311A and 311B, whose bases 311a differ in depth from each other.

In the example shown in FIG. 17, the depth of the base 311a of each first type of slot 311A is greater than the depth of the base 311a of each first type of slot 311B. In other words, the bases 311a of the first type of slots 311A are at a higher position than are the bases 311a of the first type of slots 311B. The first type of slots 311A and the first type of slots 311B alternate along the first direction (the Y direction). Two adjacent first type of slots 311A and 311B neighboring along the Y direction are connected to one second type of slot 312. The first type of slots 311B are closer to the feeding point than are the first type of slots 311A.

Thus, by altering the depth of the base 311a from slot to slot, the phase of an electromagnetic wave propagating through the waveguide on the waveguide member 322 can be adjusted. The first type of slots 311A and 311B are similar in construction to the first type of slots 311 according to the first example embodiment except for the differing depths of their bases 311a. The construction of the second type of slots 312 is similar to the construction of the second type of slots 312 of the first example embodiment.

FIG. 18 is a perspective view showing the second conductive member 320 as well as the waveguide member 322 and the plurality of conductive rods 324 thereon. FIG. 19 is an upper plan view showing a relative positioning of the first type of slots 311, the second type of slots 312, the waveguide member 322, and the conductive rods 324. The waveguide member 322 in the present example embodiment is shorter than the waveguide member 322 of the first example embodiment. As shown in FIG. 17 to FIG. 19, in the present example embodiment, an end 322e of the waveguide member 322 at the terminating end of the waveguide is located near a position immediately under the lateral portion of an H-shaped second type of slot 312. By thus reducing the length of the waveguide member 322, the amount of radiation from the radiating element at the terminating end can be adjusted so as to be small.

The slot array antenna according to each of the above-described example embodiments includes only one row of slots which are arranged along the Y direction (first direction); the present disclosure is not limited to such a construction. Alternatively, a slot array antenna including a plurality of slot rows flanking one another in a direction that intersects the first direction may be constructed. With such construction, an array antenna in which radiating elements are arranged in a two-dimensional array can be realized.

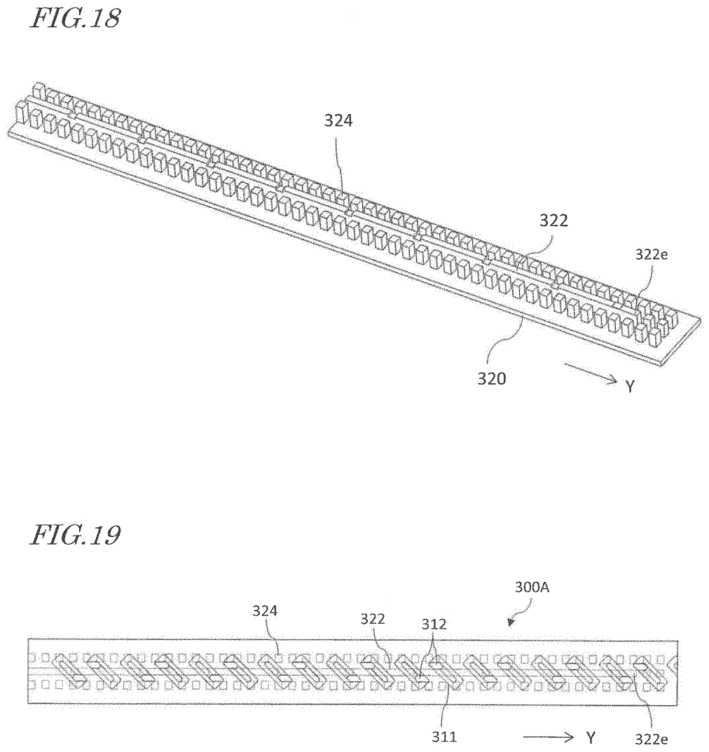

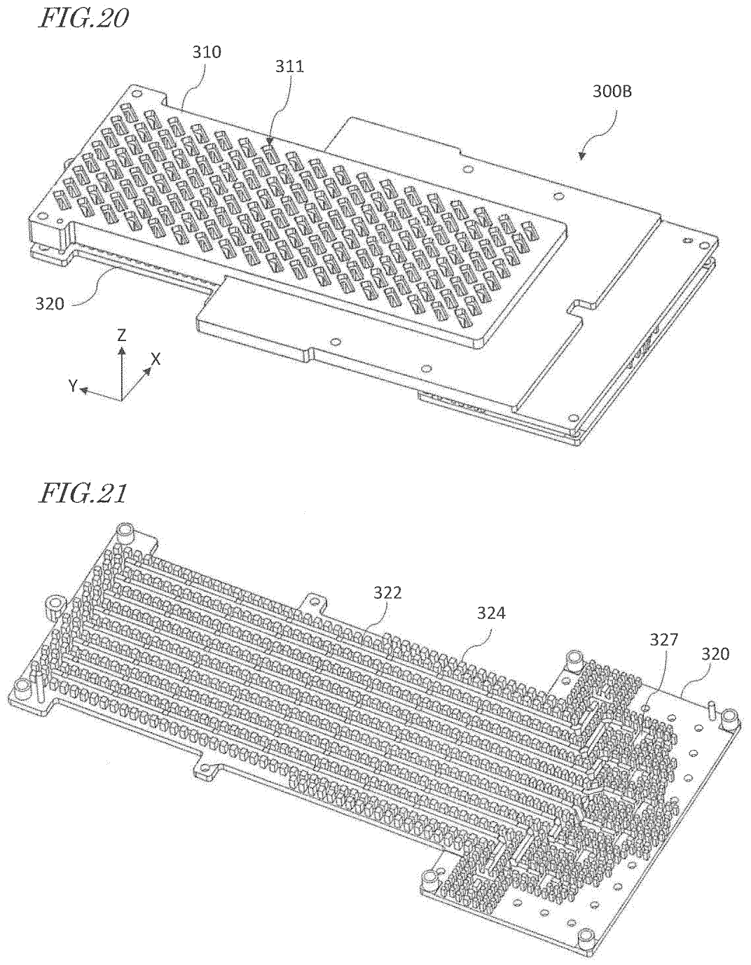

FIG. 20 is a perspective view showing an example of a slot array antenna in which a plurality of radiating elements are arranged in a two-dimensional array. FIG. 21 is a perspective view showing the construction of a slot array antenna 300B without the first conductive member 310, such that the second conductive member 320 is exposed. In the slot array antenna 300B, the first conductive member 310 has a plurality of first type of slots 311 which are arranged in a two-dimensional array along the X direction and along the Y direction. The second conductive member 320 includes a plurality of waveguide members 322 arranged along the X direction. A plurality of rows of conductive rods 324 are disposed on opposite sides of each waveguide member 322. The feeding end of each waveguide member 322 is connected to a port 327. Each port 327 is a throughhole that is connected to an electronic circuit such as an microwave integrated circuit that is not shown. Such an electronic circuit functions as a transmission circuit or a reception circuit. The electronic circuit may be provided on the rear side of the second conductive member 320 shown in FIG. 21, for example. Various constructions may be adopted to achieve feeding for the waveguide on each waveguide member 322. Examples thereof are disclosed in U.S. Pat. Nos. 10,042,045, 10,090,600, 10,158,158, International Patent Application Publication No. 2018/207796, International Patent Application Publication No. 2018/207838, and U.S. patent application Ser. No. 16/121,768, for example. The entire disclosure of each of these documents is incorporated herein by reference.

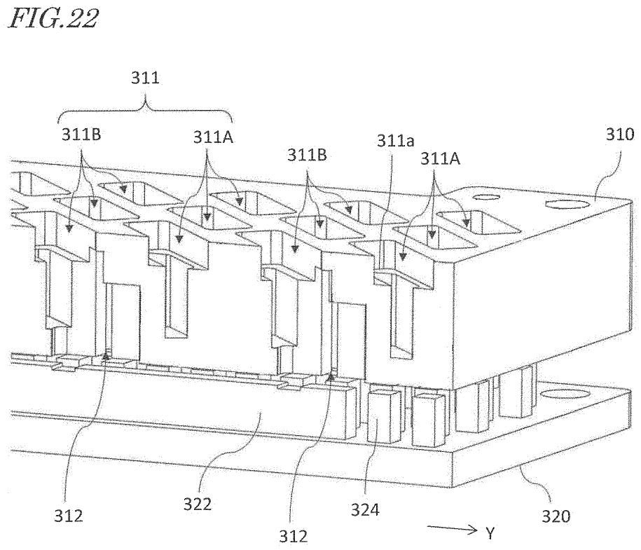

FIG. 22 is a diagram showing a cross-sectional structure at the terminating end of the slot array antenna 300B. As shown in FIG. 22, bases 311a of first type of slots 311 arranged along the Y direction have different depths from slot to slot, similarly to the example of FIG. 17. Regarding the two adjacent first type of slots 311 connected to one second type of slot 312, the base 311a of the first type of slot 311B that is closer to the feeding end has a larger depth than the depth of the base 311a of the first type of slot 311A that is closer to the terminating end. The bases 311a of any adjacent first type of slots neighboring along the X direction are equal in depth.

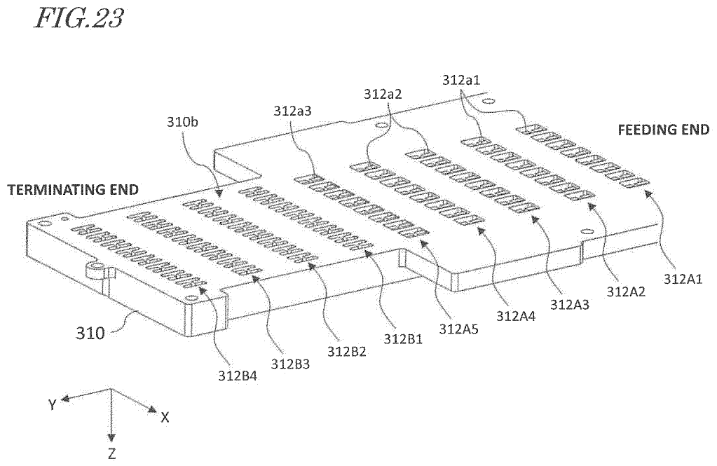

FIG. 23 is a perspective view showing the structure at the rear side of the first conductive member 310. As shown in FIG. 23, a plurality of second type of slots 312 are arranged in a two-dimensional array along the X direction and along the Y direction. On the inside of five rows of second type of slots 312A1, 312A2, 312A3, 312A4 and 312A5 existing at the feeding end, recesses 312a1, 312a2 and 312a3 are provided. In each of the recesses 312a1, 312a2 and 312a3, the end faces of the pair of ridge portions are dented backward from the second conductive surface 310b. In the example of FIG. 23, the end faces of the respective ridge portions become higher in position toward the terminating end as follows, in descending order: the recesses 312a1 of the two rows of second type of slots 312A1 and 312A2 that are the closest to the feeding end having the largest depth; the recesses 312a2 of the second type of slots 312A3 and 312A4 in the third row and the fourth row having the second largest depth; and the recesses 312a3 of the second type of slots 312A5 in the fifth row having the least depth. On the other hand, four rows of second type of slots 312B1, 312B2, 312B3 and 312B4 at the terminating end have no recesses.

In the slot array antenna of the present example embodiment, as well as in the first example embodiment, it is possible to adjust coupling between the waveguide that is defined by the waveguide member 322 and each second type of slot 312. For example, a cosecant-squared characteristic can be realized.

In the present example embodiment, the end faces of the pair of ridge portions of each of the plurality of second type of slots 312 are on the same plane as the second conductive surface 310b, or backward of the second conductive surface 310b; however, such a structure is not a limitation. For example, as in Example Embodiment 1, the end faces of the pair of ridge portions of some second type of slots 312 may be protrusions protruding from the second conductive surface 310b. With a structure in which at least one of the plurality of second type of slots 312 has recesses of an appropriate depth or protrusions of an appropriate height provided at positions adjoining the lateral portion and the vertical portion, the radiation characteristics can be adjusted in accordance with the required performance.

Note that the construction according to the present example embodiment where radiating elements are arranged in a two-dimensional array is also applicable to the structure of Example Embodiment 1, and the structure in any other example embodiment that will be described below.

### Example Embodiment 3

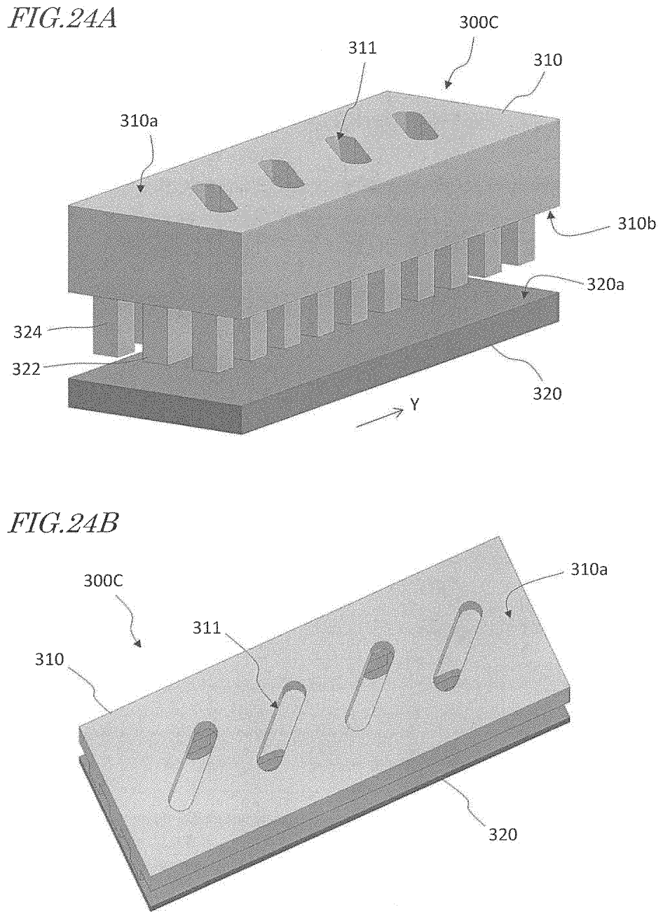

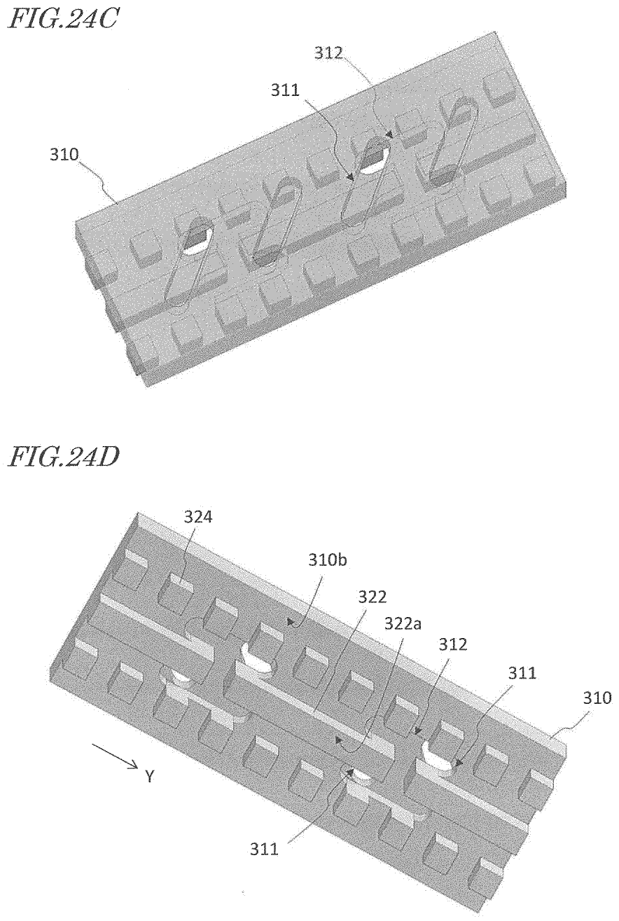

FIG. 24A is a perspective view schematically showing the structure of a slot array antenna 300C according to a third example embodiment. FIG. 24B is a perspective view showing the construction at the front side of a first conductive member 310 of the slot array antenna 300C. FIG. 24C is a see-through perspective view showing the structure of the first conductive member 310. FIG. 24D is a perspective view showing the structure at the rear side of the first conductive member 310.

In the slot array antenna 300C according to the present example embodiment, a waveguide member 322 and a plurality of conductive rods 324 are provided on the first conductive member 310. Each of the example embodiments described above was structured so that the waveguide member 322 had a ridge-like structure protruding from the third conductive surface 320a of the second conductive member 320. On the other hand, in the present example embodiment, the waveguide member 322 has a ridge-like structure protruding from the second conductive surface 310b of the first conductive member 310. Similarly, the plurality of conductive rods 324 are connected to the second conductive surface 310b.

As shown in FIGS. 24A through 24C, in the present embodiment, too, the opening in the first conductive surface 310a of each of the plurality of first type of slots 311 extends in a second direction that is inclined with respect to the first direction (the Y direction). As shown in FIG. 24D, the waveguide member (ridge) 322, which has an electrically-conductive waveguide face 322a opposing the third conductive surface 320a, extends along the Y direction. The plurality of conductive rods 324 are disposed around the waveguide member 322 to suppress leakage of an electromagnetic wave propagating along the waveguide face 322a. In the present example embodiment, the waveguide member 322 and its waveguide face 322a are split at the positions of the respective lateral portions of the second type of slots 312. Stated otherwise, the waveguide member 322 includes a plurality of ridges which are separated from one another and which extend in the same direction. The gap between the end faces of any of these ridges is continuous with the lateral portion of a second type of slot.

With such structure, an electromagnetic wave propagating along the waveguide face 322a of one ridge of the waveguide member 322 is in one part radiated toward the external space via each second type of slot 312 and the two first type of slots 311, and in another part propagates along another ridge that exists ahead. With the construction of the present example embodiment, too, as in the above example embodiments, electromagnetic waves can be radiated from the plurality of first type of slots 311.

The second type of slots 312 in the above example embodiments all have an H shape. However, the shape of the second type of slots 312 is not limited to an H shape. Hereinafter, other exemplary shapes for the second type of slots 312 will be described.

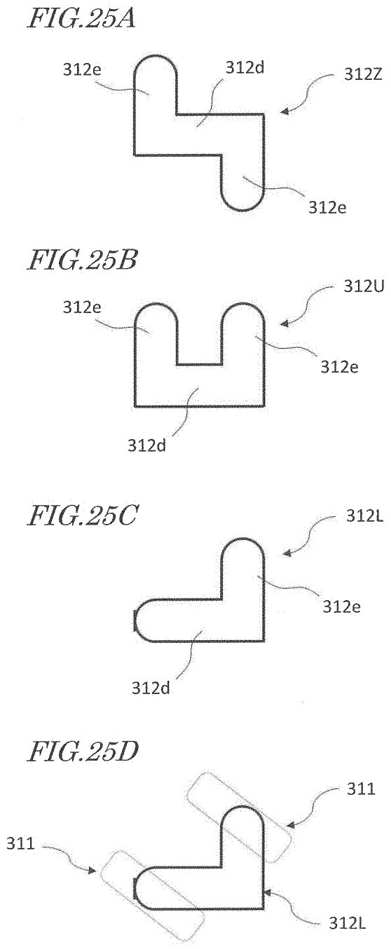

FIG. 25A shows an example of a second type of slot 312Z having a Z shape. The second type of slot 312Z has a cross-sectional shape resembling the alphabetical letter “Z”. The slot 312Z includes a lateral portion 312d extending in one direction, and two vertical portions 312e which are connected to both ends of the lateral portion 312d and which extend in a direction that intersects the lateral portion 312d. The directions that the two vertical portions 312e extend, beginning at both ends of the lateral portion 312d, are opposite to each other.

FIG. 25B shows an example of a second type of slot 312U having a U shape. The second type of slot 312U has a cross-sectional shape resembling the alphabetical letter “U”. The slot 312U also includes a lateral portion 312d extending in one direction, and two vertical portions 312e which are connected to both ends of the lateral portion 312d and which extend in a direction that intersects the lateral portion 312d. Unlike in the Z-shaped slot 312Z, the directions that the two vertical portions 312e extend, beginning at both ends of the lateral portion 312d, are identical.

FIG. 25C shows an example of a second type of slot 312L having an L shape. The second type of slot 312L has a cross-sectional shape resembling the alphabetical letter “L”. The slot 312L includes a lateral portion 312d extending in one direction, and a vertical portion 312e which is connected to one end of the lateral portion 312d and which extends in a direction that intersects the lateral portion 312d. The second type of slot 312L differs from each second type of slot described above in that it only has one vertical portion 312e that is connected to the lateral portion 312d. Such an L-shape structure also makes possible a structure in which each second type of slot 312L is continuous with two adjacent first type of slots 311 inside the first conductive member 310. For example, as shown in FIG. 25D, a structure may be adopted where the lateral portion 312d of the second type of slot 312L overlaps one of the first type of slots 311, while the vertical portion 312e of the second type of slot 312L overlaps the other first type of slot 311. In the construction of FIG. 25D, the direction in which the plurality of first type of slots 311 are arranged is not identical with the direction in which the plurality of second type of slots 312 are arranged.

Instead of the H-shape second type of slots 312 in each of the above-described example embodiments, any of the second type of slots illustrated in FIGS. 25A through 25C may be used.

### Example Embodiment 4

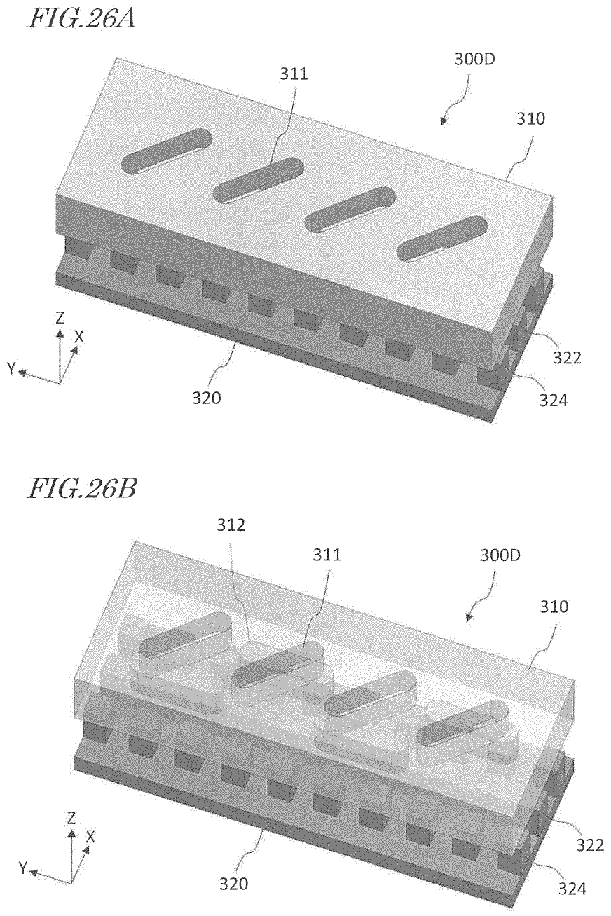

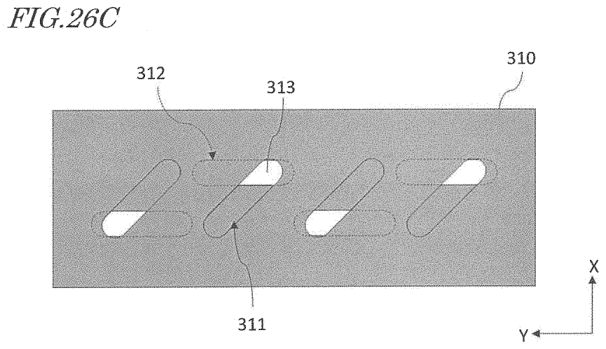

FIG. 26A is a perspective view showing the structure of a slot array antenna 300D according to a fourth example embodiment of the present disclosure. FIG. 26B is a see-through perspective view showing the internal structure of the slot array antenna 300D. FIG. 26C is an upper plan view showing a relative positioning of the first type of slots 311 and the second type of slots 312.

The present example embodiment differs from the each of the above-described example embodiments that one second type of slot 312 is continuous with one first type of slot 311. Each second type of slot 312 according to the present example embodiment has a near elliptical shape. The direction that each second type of slot 312 extends is parallel to the first direction (the Y direction) that the waveguide member 322 extends. Each of the plurality of second type of slots 312 is displaced in the +X direction or the −X direction from the center line of the waveguide face of the waveguide member 322. The directions of such displacement are opposite between two adjacent second type of slots 312 neighboring along the Y direction. Thus, the plurality of second type of slots 312 according to the present example embodiment are in a staggered arrangement. Similarly to each of the above-described example embodiments, the direction that the opening of each first type of slot 311 extends is a second direction that is inclined with respect to the first direction. Inside the first conductive member 310, each second type of slot 312 only has one site of connection at which it connects to the first type of slot 311. At this site of connection, the first conductive member 310 has a throughhole 313.

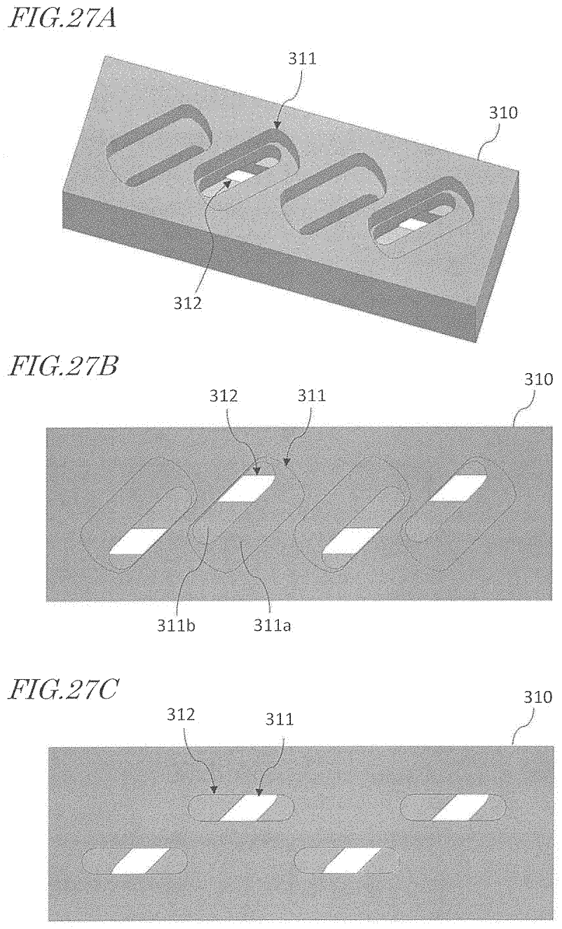

FIG. 27A is a perspective view showing the structure of a first conductive member 310 according to a variant of the present example embodiment. FIG. 27B is a diagram showing the first conductive member 310 according to this variant as viewed from the front side. FIG. 27C is a diagram showing the first conductive member 310 according to this variant as viewed from the rear side. In this example, each first type of slot 311 has a base 311a and a groove 311b. The groove 311b adjoins the inner wall surface of the first type of slot 311. In the two adjacent first type of slots 311, the grooves 311b are displaced in opposite directions from the central portion of each slot. With such structure, the sites of connection between the second type of slots 312 and the first type of slots 311 can be arranged at a constant interval along the first direction, whereby good radiation can be achieved.

A slot array antenna according to an example embodiment of the present disclosure can also be used in a wireless communication system. Such a wireless communication system would include a slot array antenna according to any of the above example embodiments and a communication circuit (a transmission circuit or a reception circuit) connected to the slot array antenna. For example, the transmission circuit may be configured to supply, to a waveguide within the slot array antenna, a signal wave representing a signal for transmission. The reception circuit may be configured to demodulate a signal wave which has been received via the slot array antenna, and output it as an analog or digital signal.

A communications technique called Massive MIMO has been known in the recent years. Massive MIMO is a technique which in some cases employs 100 or more antenna elements to realize a drastic increase in channel capacity. According to Massive MIMO, a multitude of users are able to simultaneously connect by using the same frequency band. Massive MIMO is useful in utilizing a relatively high frequency such as the 20 GHz band, and may be utilized in communications under the 5th-generation wireless systems (5G) or the like. An antenna array according to an example embodiment of the present disclosure can be used in communication systems utilizing Massive MIMO.

A slot array antenna according to an example embodiment of the present disclosure can also be used in a radar device or a radar system to be incorporated in moving entities such as vehicles, marine vessels, aircraft, robots, or the like, for example. A radar device would include a slot array antenna according to an example embodiment of the present disclosure and a microwave integrated circuit, e.g., MMIC, that is connected to the slot array antenna. A radar system would include the radar device and a signal processing circuit that is connected to the microwave integrated circuit of the radar device. The signal processing circuit may be configured to estimate an azimuth of each arriving wave by executing an algorithm such as the MUSIC method, the ESPRIT method, or the SAGE method, and output a signal indicating the estimation result. The signal processing circuit may further be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoCs). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory devices (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

When an antenna device according to an example embodiment of the present disclosure and a WRG structure that permits downsizing are combined, it will allow the area of the face on which antenna elements are arrayed to be reduced as compared to a conventional construction using a hollow waveguide. Therefore, a radar system incorporating the antenna device can be easily mounted in narrow places. The radar system may be used while being fixed on the road or a building, for example.

A slot array antenna according to an example embodiment of the present disclosure can further be used as an antenna in an indoor positioning system (IPS). An indoor positioning system is able to identify the position of a moving entity, such as a person or an automated guided vehicle (AGV), that is in a building. A slot array antenna can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. Nos. 9,786,995 and 10,027,032, for example. The entire disclosure of these publications is incorporated herein by reference. A slot array antenna according to the present disclosure is applicable to each application example that is disclosed in these publications.

A slot array antenna according to the present disclosure is usable in any technological field that makes use of an antenna. For example, they are available to various applications where transmission/reception of electromagnetic waves of the gigahertz band or the terahertz band is performed. In particular, they may be used for constructing various systems which may require smallsized and high-gain antennas. As examples of such systems, they may be suitably used in onboard radar systems, various types of monitoring systems, indoor positioning systems, wireless communication systems such as Massive MIMO, etc.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A slot array antenna comprising:
a first electrical conductor including a first electrically conductive surface and a second electrically conductive surface that is located on an opposite side from the first electrically conductive surface;
a second electrical conductor including a third electrically conductive surface opposing the second electrically conductive surface;
a waveguide located between the first electrical conductor and the second electrical conductor, the waveguide including an electrically-conductive waveguide surface opposing the second electrically conductive surface or the third electrically conductive surface, and the waveguide extending in a direction that extends along the second electrically conductive surface or the third electrically conductive surface; and
a plurality of electrically conductive rods disposed around the waveguide; wherein
the first electrical conductor includes:
a plurality of first type of slots that open in the first electrically conductive surface, the plurality of first type of slots being arranged in a first direction; and
a plurality of second type of slots that open in the second electrically conductive surface, the plurality of second type of slots being arranged in the first direction;
an opening in the first electrically conductive surface of each of the plurality of first type of slots has a shape extending along a second direction that is inclined with respect to the first direction;
each of the plurality of second type of slots includes a lateral portion extending along a third direction that intersects the first direction and a vertical portion being connected to the lateral portion and extending along a fourth direction that intersects the third direction;
inside the first electrical conductor, each of the plurality of second type of slots includes two or more sites of connection at which the second type of slot is connected to two adjacent first type of slots among the plurality of first type of slots;
at least one of the two or more sites of connection is a site at which the vertical portion of the second type of slot is connected to the first type of slot; and
the waveguide surface is opposed to the respective lateral portions of the second type of slots, or is split at positions corresponding to the respective lateral portions of the second type of slots.

2. The slot array antenna of claim 1, wherein
the waveguide includes a ridge-shaped structure protruding from the third electrically conductive surface; and
the waveguide surface is opposed to the second electrically conductive surface and to the respective lateral portions of the second type of slots.

3. The slot array antenna of claim 1, wherein
the waveguide includes a ridge-shaped structure protruding from the third electrically conductive surface;
the waveguide surface is opposed to the second electrically conductive surface and to the respective lateral portions of the second type of slots;
the first electrical conductor includes one or more recesses in the second electrically conductive surface; and
at least one of the one or more recesses adjoins the lateral portion and the vertical portion of one of the plurality of second type of slots.

4. The slot array antenna of claim 1, wherein
the waveguide includes a ridge-shaped structure protruding from the third electrically conductive surface;
the waveguide surface is opposed to the second electrically conductive surface and to the respective lateral portions of the second type of slots;
the first electrical conductor includes one or more protrusions on the second electrically conductive surface; and
at least one of the one or more protrusions adjoins the lateral portion and the vertical portion of one of the plurality of second type of slots.

5. The slot array antenna of claim 3, wherein
the first electrical conductor includes one or more protrusions on the second electrically conductive surface; and
at least one of the one or more protrusions adjoins the lateral portion and the vertical portion of one of the plurality of second type of slots.

6. The slot array antenna of claim 1, wherein the plurality of second type of slots include two or more second type of slots which differ from one another in terms of distance between a site thereof adjoining the lateral portion and the vertical portion and the third electrically conductive surface.

7. The slot array antenna of claim 1, wherein
the waveguide includes a ridge-shaped structure protruding from the third electrically conductive surface;
the waveguide surface is opposed to the second electrically conductive surface and to the respective lateral portions of the second type of slots; and
the plurality of second type of slots include two or more second type of slots which differ from one another in terms of distance between a site thereof adjoining the lateral portion and the vertical portion and the third electrically conductive surface.

8. The slot array antenna of claim 1, wherein
at least one of the plurality of second type of slots includes two of the vertical portions;
one of the two vertical portions is connected to the lateral portion at one site, and another of the two vertical portions is connected to the lateral portion at another site;
one of the two or more sites of connection is a site at which one of the two vertical portions is connected to one of the plurality of first type of slots, and another of the two or more sites of connection is a site at which another of the two vertical portions is connected to another of the plurality of first type of slots; and
an interval between the one and the other of the plurality of first type of slots is narrower than an interval between two adjacent ones among the plurality of second type of slots.

9. The slot array antenna of claim 1, wherein
the plurality of second type of slots include two or more second type of slots which differ from one another in terms of distance between a site thereof adjoining the lateral portion and the vertical portion and the third electrically conductive surface;
at least one of the plurality of second type of slots includes two said vertical portions;
one of the two vertical portions is connected to the lateral portion at one site, and another of the two vertical portions is connected to the lateral portion at another site;
one of the two or more sites of connection is a site at which one of the two vertical portions is connected to one of the plurality of first type of slots, and another of the two or more sites of connection is a site at which another of the two vertical portions is connected to another of the plurality of first type of slots; and
an interval between the one and the other of the plurality of first type of slots is narrower than an interval between two adjacent ones among the plurality of second type of slots.

10. The slot array antenna of claim 1, wherein
each of the plurality of first type of slots includes a base that includes a bottom; and
the base includes a groove extending along the second direction.

11. The slot array antenna of claim 1, wherein
each of the plurality of first type of slots includes a base that includes a bottom; and
the plurality of second type of slots include two or more second type of slots which differ from one another in terms of distance between a site thereof adjoining the lateral portion and the two vertical portion and the third electrically conductive surface.

12. The slot array antenna of claim 8, wherein
each of the plurality of first type of slots includes a base that includes a bottom; and
the respective bases of the two first type of slots that are connected to each second type of slot differ from each other in terms of depth.

13. The slot array antenna of claim 9, wherein
each of the plurality of first type of slots includes a base that includes a bottom; and
the respective bases of the two first type of slots that are connected to each second type of slot differ from each other in terms of depth.

14. The slot array antenna of claim 1, wherein
a portion of the vertical portion extends through the first electrical conductor from the first electrically conductive surface to the second electrically conductive surface; and
the lateral portion includes a bottom inside the first electrical conductor.

15. The slot array antenna of claim 1, wherein
each of the plurality of first type of slots includes a base that includes a bottom;
the respective bases of the two first type of slots that are connected to each second type of slot differ from each other in terms of depth;
a portion of the vertical portion extends through the first electrical conductor from the first electrically conductive surface to the second electrically conductive surface; and
the lateral portion includes another bottom inside the first electrical conductor.

16. The slot array antenna of claim 1, wherein
the plurality of second type of slots include two or more second type of slots which differ from one another in terms of distance between a site thereof adjoining the lateral portion and the vertical portion and the third electrically conductive surface;
a portion of the vertical portion extends through the first electrical conductor from the first electrically conductive surface to the second electrically conductive surface; and
the lateral portion includes a bottom inside the first electrical conductor.

17. The slot array antenna of claim 1, wherein
the waveguide includes a ridge-shaped structure protruding from the second electrically conductive surface;
the plurality of electrically conductive rods are connected to the second electrically conductive surface; and
the waveguide surface is opposed to the third electrically conductive surface, and is split at positions corresponding to the respective lateral portions of the second type of slots.

18. The slot array antenna of claim 1, wherein
each of the plurality of first type of slots includes a base that includes a bottom;
the respective bases of the two first type of slots that are connected to each second type of slot differ from each other in terms of depth;
the waveguide includes a ridge-shaped structure protruding from the second electrically conductive surface;
the plurality of electrically conductive rods are connected to the second electrically conductive surface; and
the waveguide surface is opposed to the third electrically conductive surface, and is split at positions corresponding to the respective lateral portions of the second type of slots.

19. A wireless communication system comprising:
the slot array antenna of claim 1; and
a communication circuit that is connected to the slot array antenna.

20. A wireless communication system comprising:
the slot array antenna of claim 1; and
a communication circuit that is connected to the slot array antenna; wherein,
each of the plurality of first type of slots includes a base that includes a bottom;
a portion of the two vertical portions extends through the first electrical conductor from the first electrically conductive surface to the second electrically conductive surface; and
the lateral portion includes another bottom inside the first electrical conductor.
